(19) United States
(12) Patent Application Publication
(10) Pub. No.: US 2023/0382750 A1
(43) Pub. Date: Nov. 30, 2023

(54) A METHOD FOR THE PRODUCTION OF AMMONIA

(71) Applicant: TYKHE TECH PTE. LTD., Singapore (SG)

(72) Inventor: Srecko VUKSAN, Khlong Luang Pathumthani (TH)

(73) Assignee: TYKHE TECH PTE. LTD., Singapore (SG)

(21) Appl. No.: 18/249,627

(22) PCT Filed: Oct. 19, 2021
(86) PCT No.: PCT/IL2021/051240

§ 371 Date: Apr. 19, 2023

(30) Foreign Application Priority Data
Oct. 20, 2020 (IL) 278193

(51) Int. Cl. C01C 1/04; C01B 3/08; C01B 3/02

(52) U.S. Cl. CPC C01C 1/0417; C01B 3/08; C01B 3/025

(57) ABSTRACT

The present invention relates to a process of producing ammonia from nitrogen in the presence of water, an iron-containing substance and carbon dioxide (CO₂) or a carbon dioxide precursor.

### FIELD OF THE INVENTION

The present invention relates to a process of producing ammonia from nitrogen in the presence of water, an iron-containing substance and carbon dioxide (CO₂) or a carbon dioxide precursor.

### BACKGROUND OF THE INVENTION

The development of mass-produced fertilizer revolutionized the agriculture industry by maximizing the crop yield that can be grown on a given parcel of land. Fertilizers, along with irrigation systems to relieve dependence on natural precipitation, allow a predictable, optimal yield of agricultural stock from farmland. Fertilizer production employs substantial amounts of ammonia. In solid or liquid states, ammonia-based salts and solutions are the active components of most synthetic fertilizers used in agriculture, which demands for ammonia production. The primary industrial method for ammonia (NH₃) synthesis is the Haber-Bosch process, created by Fritz Haber in 1905 and developed for industry by Carl Bosch in 1910. The overall process synthesizes ammonia from molecular nitrogen and hydrogen by feeding the reactants over iron catalysts at a high pressure and temperature, requiring bulky, well-insulated reactors to house the process, and large quantities of natural gas.

The Haber process is employed to synthesize approximately 150 million tons of ammonia annually and has allowed the earth to sustain a greatly increased population. However, the use of natural gas as a source of hydrogen and energy needed to derive nitrogen from atmospheric air have been the subjects of environmental concern. The industrial use and geological extraction of natural gas are known to contribute to carbon dioxide emissions and water pollution, respectively, and today an estimated 59% of natural gas produced in the United States is used in ammonia synthesis to meet the high demand of gaseous hydrogen. Approximately 80% of ammonia synthesized today is eventually converted into urea fertilizer, a dense nitrate that is more stable at room temperature, allowing easier storage and transportation than ammonia.

Carbon dioxide is one of the most significant greenhouse gases (GHG) in the Earth's atmosphere with current global average concentration of 409 ppm (0.041%) by volume, or 622 ppm (0.062%) by mass. Human activities emit approximately 30 billion tons of CO₂ every year, half of which remains in the atmosphere as a GHG and is not absorbed by vegetation and/or the oceans. One of the challenges of the 21^{st} century is to meet the increasing energy needs of a continuously growing population and economy while simultaneously decreasing carbon dioxide emissions. Carbon dioxide (CO₂) Capture and Storage, also referred to as Carbon Capture and Sequestration (CCS) is the process of managing produced CO₂ (mainly from combustion waste emitted from large point sources, such as fossil fuel power plants), transporting it to a storage site, and depositing it in a manner that keeps the CO₂ from re-entering the atmosphere. Post-production CCS, i.e., removal of the CO₂ after combustion, is considered one of the most promising strategies to achieve this objective. Currently available technologies, however, can raise energy costs by 30% to 70% (Leung et al., Renewable and Sustainable Energy Reviews 39 (2014) 426-443) and are therefore considered prohibitively expensive and have yet to be widely implemented.

Most captured CO₂ is used in enhanced oil recovery (EOR) to recover additional oil from underground oil fields where the CO₂ is then permanently stored. This use is limited in scope and constrained by the availability of appropriate Earth's natural resources and transportation costs. The global size of the CO₂ re-use market (in carbonate aggregates, fuels, concrete, methanol, and polymers) is estimated to reach $700 billion by 2030, utilizing 7 billion metric tons of CO 2 per year, the equivalent to approximately half of the annual amount of CO₂ which remains in the atmosphere due to human activities (or 15% of current global CO₂ emissions).

GB 155592 describes a process for the production of ammonia through a reaction between nitrogen and hydrogen in the presence of a catalyst. The catalyst for this synthesis consists of an alkali or alkaline-earth metal iron cyanide, e.g. potassium ferricyanide or calcium ferrocyanide, distributed upon a porous support, such as pumice. The reaction requires elevated temperatures of around 450-600° C. and elevated pressures of 100 atmospheres.

GB 258887 discloses a process of producing ammonia wherein a purified mixture of nitrogen and hydrogen in the volume proportions of 1:3 and containing 2% of carbon monoxide is compressed by to 900 atmospheres and conducted through a catalytic apparatus containing a heated catalyst. The catalyst comprises zinc oxide prepared by igniting precipitated zinc carbonate, or a mixture of zinc and chromium oxides obtained by adding ammonia to a solution of zinc and chromium nitrates.

GB 974439 discloses a process for producing ammonia by reacting nitrogen and hydrogen at elevated temperature and pressure over an iron catalyst which is replaced at intervals in its entirety.

JP 2000/247632 discloses a process for the production of ammonia through a reaction between active nitrogen adsorbed on a catalyst and atomic hydrogen released from a diaphragm. Specifically, a hydrogen permeable membrane is used as the diaphragm, and active atomic released therefrom. The catalyst may be an iron-based ternary catalyst.

JP 2010/064912 discloses a method for producing ammonia in temperature conditions. The method involves the formation of a metal amide through a chemical reaction of a metal hydride and nitrogen. Subsequently, ammonia is produced by a chemical reaction of the metal amide and hydrogen. The metal amide forming step in performed at normal temperature and the ammonia forming step is conducted at around 300° C.

CN 102815721 describes a method for a low-pressure ammonia synthesis. The method involves a reaction between hydrogen and nitrogen in the presence of a ruthenium-based catalyst or iron-ruthenium catalyst at a pressure of 5-10 MPa (50-100 Bar) and temperature of 300-425° C.

WO 2012/077658 is directed to production of ammonia through a reaction between hydrogen and nitrogen in the presence of an ammonia synthesis catalyst. The ammonia synthesis catalyst comprises a supported metal catalyst using a mayenite type compound containing a conduction electron of 10¹⁵ cm⁻³ or more as a carrier for the ammonia synthesis catalyst, wherein the mayenite type compound is 12CaO·7Al₂O₃.

CN 110252376 discloses a process of producing ammonia through a process between hydrogen and nitrogen in the presence of a photo-catalyst. The reaction may proceed at room temperature, wherein the photo-catalyst is active under sunlight irradiation to carry out the reaction.

There is still an unmet need for a cost-effective procedure for the preparation of ammonia that uses inexpensive starting materials and does not require very significant investment of external heat.

### SUMMARY OF THE INVENTION

According to some aspects and embodiments, there are provided processes for producing NH₃. The processes comprise contacting simultaneously or sequentially water, an iron-containing material, a CO₂ source and nitrogen (N₂). The iron containing material may be either metallic iron, Fe⁰, oxidized iron, such as Fe(II), Fe(II-III) and/or Fe(III) oxides, or combinations thereof. The CO₂ source may be a CO₂ gas, solid CO₂ (dry ice) or a CO₂ precursor, such as carbonic acid, or a combination, a carbonate or a bicarbonate with an acid.

According to a first aspect, there is provided a process for producing NH₃, the process comprising contacting water, an iron-containing material, and a CO₂ source selected from the group consisting of CO₂ and a CO₂ precursor with nitrogen (N₂) in a reactor thereby producing NH₃.

According to some embodiments, the process comprises contacting the nitrogen with a mixture of the water, the iron-containing material and the CO₂ source.

According to another embodiment, the process is performed in a single step in a closed reactor. According to some embodiments, the single step is resulting in a spontaneous reaction. According to some embodiments, the contacting of the nitrogen with the water, the iron-containing material, and the CO₂ source comprises reacting the nitrogen, the water, the iron-containing material, and the CO₂ source.

According to some embodiments, the contacting of the water, the iron-containing material, and the CO₂ source with nitrogen is performed in a single step in a closed reactor. According to some embodiments, the process comprises the steps of:
(1b) placing the water, the iron-containing material, the CO₂ source, and the nitrogen in the closed reactor in a closed process environment, thereby producing NH₃; and
(2b) collecting the produced NH₃.

According to some embodiments, upon said contacting of the water, the iron-containing material, and the CO₂ source with nitrogen, a reaction occurs, thereby producing NH₃, wherein the process further comprises a step of collecting the produced NH₃.

According to further embodiments, the process is performed by contacting of the water, the iron-containing material, and the CO₂ source for a period of time followed by admixing of nitrogen thereby producing NH₃.

According to some embodiments, the process is performed in the absence of electrolysis. According to some embodiments, the process is performed in the absence of irradiation in a closed reactor. According to some embodiments, the process is performed at a temperature of about 290° C. or less. According to some embodiments, the process is performed in the absence of any one of external thermal energy and electric energy. According to some embodiments, the process is performed in the absence of any type of added external energy, including light irradiation.

According to some embodiments, the contact between the water, the iron-containing material, the CO₂ source and the nitrogen is performed in a reactor at a temperature below 100° C., e.g. at a temperature in the range of −30° C. and 50° C., including at ambient temperatures. According to some embodiments, the process comprises contacting a mixture of the CO₂ source, the water, and the iron-containing material with the nitrogen. According to some embodiments, said contacting of the mixture with the nitrogen is performed in a reactor at a temperature below 100° C., e.g. at a temperature in the range of −30° C. and 50° C., including at ambient temperatures. According to some embodiments, the contact between the water, the iron-containing material, the CO₂ source and the N₂ is performed in a reactor at a temperature in the range of −5° C. and 50° C., including each value within the specified range.

The present invention is based in part on the surprising discovery that NH₃ can be formed by reacting water, an iron-containing substance, and carbon dioxide (CO₂) or a carbon dioxide generator with nitrogen at relatively low temperatures, even without external heating.

According to some embodiments, the step of contacting water, an iron-containing material, and a CO₂ source with nitrogen is performed in the absence of external thermal energy. According to some embodiments, the step of contacting water, an iron-containing material, and a CO₂ source with nitrogen is performed in the absence of external electric energy. According to some embodiments, the step of contacting water, an iron-containing material, and a CO₂ source with nitrogen is performed in the absence of external radiant energy. According to some embodiments, the step of contacting water, an iron-containing material, and a CO₂ source with nitrogen is performed in the absence of external energy. According to some embodiments, the step of contacting water, an iron-containing material, and a CO₂ source is performed in the absence of external thermal energy. According to some embodiments, the step of contacting water, an iron-containing material, and a CO₂ source is performed in the absence of external electric energy. According to some embodiments, the step of contacting water, an iron-containing material, and a CO₂ source is performed in the absence of external radiant energy. According to some embodiments, the step of contacting water, an iron-containing material, and a CO₂ source is performed in the absence of external energy.

The process can further be used for recycling of iron waste and in carbon dioxide capture and storage.

In various embodiments, the process further comprises recycling of iron waste thereby producing an iron oxide, iron carbonate or both. In various embodiments, the process further comprises recycling of iron waste thereby producing an iron oxide. In further embodiments, the process further comprises a step of collecting an iron-containing product of the reaction. In particular embodiments, the iron oxide comprises iron (II) oxide (FeO).

In additional embodiments, the process further comprises capturing carbon dioxide.

In certain embodiments, the water is selected from the group consisting of tap water, sea water, partially purified water, deionized water, distilled water, brackish water, and waste water. Each possibility represents a separate embodiment. According to some embodiments, the water is in the liquid state.

In other embodiments, the iron-containing material is selected from the group consisting of an iron metal Fe⁰, an iron alloy, an Fe⁰ complex, an iron oxide, an iron carbonate, and a mixture or combination thereof. Each possibility represents a separate embodiment. In particular embodiments, the iron-containing material is an iron metal Fe⁰. In other particular embodiments, iron-containing material is an iron oxide.

In further embodiments, the iron-containing material comprises iron waste. In further embodiments, the iron-containing material comprises iron industrial waste.

According to some embodiments, the iron-containing material comprises iron-containing coal combustion product.

In some embodiments, the iron-containing material is in the form of a powder, shavings, bars, chips, or granules. Each possibility represents a separate embodiment. In specific embodiments, the iron-containing material is in the form of a powder. In exemplary embodiments, the iron-containing material is in the form of a powder having an average particle size of less than 100 μm. In other exemplary embodiments, the iron-containing material is in the form of a powder having an average particle size of less than 10 μm. In particular embodiments, the iron-containing material is in the form of a powder having an average particle size of less than 5 μm. In other particular embodiments, the iron-containing material is in the form of a powder having an average particle size in the range of about 1.5 to about 4.5 μm, including each value within the specified range. In further embodiments, the iron-containing material is in the form of a powder having an average particle size in the range of about 2.5 to about 3.5 μm, including each value within the specified range.

In various embodiments, the CO₂ gas is provided as dry ice. In various embodiments, the CO₂ gas is originated from at least one of pure industrial CO₂, flue gas, a CO₂-producing plant, and atmospheric CO₂. Each possibility represents a separate embodiment. In other embodiments, the CO₂ precursor is selected from carbonic acid, a carbonate, a bicarbonate, and a mixture or combination thereof.

In some embodiments, the process is a batch production process. In other embodiments, the process is a continuous production process.

In various embodiments, the process is performed at a pH of 6.5 or less. In other embodiments, the process is performed at a pH of 6 or less. In certain embodiments, the process is performed at a pH of 5.5 or less. In further embodiments, the process is performed at a pH in the range of about 4 to about 6, including each value within the specified range. In particular embodiments, the process is performed at a pH in the range of about 5.7 to about 6, including each value within the specified range. In alternative embodiments, the process is performed at a pH of at least 6.5, for example at a pH of about 7 to about 10, including each value within the specified range. It is to be understood that reference to pH values within this paragraph is made to any one of the process steps described herein individually.

In some embodiments, the process is performed at a temperature in the range of about −30° C. to about 290° C., including each value within the specified range. In some embodiments, the process is performed at a temperature in the range of about −5° C. to about 290° C., including each value within the specified range. In some embodiments, the process is performed at a temperature in the range of about 100° C. to about 290° C., including each value within the specified range. In certain embodiments, the process is performed at a temperature in the range of about 150° C. to about 290° C., including each value within the specified range. In other embodiments, the process is performed at a temperature of about 100° C. to about 200° C., including each value within the specified range. In some embodiments, the process is performed at a temperature in the range of about −30° C. to about 100° C., including each value within the specified range. In some embodiments, the process is performed at a temperature in the range of about −15° C. to about 100° C., including each value within the specified range. In some embodiments, the process is performed at a temperature in the range of about −5° C. to about 100° C., including each value within the specified range. In certain embodiments, the process is performed at a temperature in the range of about −5° C. to about 80° C., including each value within the specified range. In other embodiments, the process is performed at a temperature of about −5° C. to about 50° C., including each value within the specified range. In some embodiments, the process does not include external heating. In some embodiments, the process does not include external cooling. It is to be understood that reference to temperatures within this paragraph is made to any one of the process steps described herein individually.

In certain embodiments, the process is performed at a pressure of about 1 Bar to about 350 Bar, including each value within the specified range. In other embodiments, the process is performed at a pressure of about 40 Bar to about 350 Bar, including each value within the specified range. In yet other embodiments, the process is performed at a pressure of about 100 Bar to about 300 Bar, including each value within the specified range. In yet other embodiments, the process is performed at a pressure higher than about 105 Bar. In yet other embodiments, the process is performed at a pressure of about 105 Bar to about 350 Bar, including each value within the specified range. It is to be understood that reference to pressures within this paragraph is made to any one of the process steps described herein individually.

In various embodiments, the process comprises performing the reaction under continuous mixing.

In some embodiments, the process further comprises adding an anti-caking agent to the reaction. In particular embodiments, the anti-caking agent is selected from the group consisting of tricalcium phosphate, powdered cellulose, magnesium stearate, sodium ferrocyanide, potassium ferrocyanide, calcium ferrocyanide, calcium phosphate, sodium silicate, silicon dioxide, calcium silicate, magnesium trisilicate, talcum powder, sodium aluminosilicate, potassium aluminum silicate, calcium aluminosilicate, bentonite, aluminum silicate, stearic acid, polydimethylsiloxane, and a mixture or combination thereof. Each possibility represents a separate embodiment.

In further embodiments, at least one of the water, the nitrogen, the iron-containing material, and the CO₂ source is pre-treated prior to the reaction thereof.

According to some embodiments, the nitrogen is provided as a gas mixture comprising at least 1% N₂ v/v. According to some embodiments, the nitrogen is provided as a gas mixture comprising at least 3% N₂ v/v. According to some embodiments, the nitrogen is provided as a gas mixture comprising at least 5% N₂ v/v. According to some embodiments, the nitrogen is provided as a gas mixture comprising at least 10% N₂ v/v. According to some embodiments, the nitrogen is provided as a gas mixture comprising at least 15% N₂ v/v. According to some embodiments, the nitrogen is provided as a gas mixture comprising at least 20% N₂ v/v. According to some embodiments, the nitrogen is provided as a gas mixture comprising at least 30% N₂ v/v. According to some embodiments, the nitrogen is provided as a gas mixture comprising at least 40% N₂ v/v. According to some embodiments, the nitrogen is provided as a gas mixture comprising at least 50% N₂ v/v. According to some embodiments, the nitrogen is provided as a gas mixture comprising at least 60% N₂ v/v. According to some embodiments, the nitrogen is provided as a gas mixture comprising at least 70% N₂ v/v. According to some embodiments, the nitrogen is provided as a gas mixture comprising at least 80% N₂ v/v. According to some embodiments, the gas mixture comprises air. According to some embodiments, the gas mixture is air.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

The accompanying figures, which are included to provide a further understanding of the invention and are incorporated in and constitute a part of this specification, illustrate embodiments of the invention and together with the description serve to explain the principles of the invention wherein:

FIG. 1 depicts a schematic description of a reactor, configured to performing a batch process according to one embodiment of the invention.

FIG. 2 is a graph depicting the evolution of ammonia produced in a process according to one embodiment of the invention.

### DETAILED DESCRIPTION OF THE INVENTION

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide compositions and methods. While potentially serving as a guide for understanding, any reference signs used herein and in the claims shall not be construed as limiting the scope thereof.

It is within the scope of the invention to disclose a method for producing ammonia from a reaction(s) involving nitrogen, carbon dioxide, water and an iron-containing material. The process further produces an iron oxide thereby being useful in the recycling of iron waste and as a manner to afford carbon dioxide capturing and storage.

According to some aspects and embodiments, there are provided processes for producing NH₃. The processes described herein may be either simultaneous or sequential and are involving water, an iron-containing material, a CO₂ source and nitrogen (N₂) as starting materials. As detailed herein, the iron containing material may include either metallic iron, Fe⁰, a composition of comprising an oxidized iron species, such as Fe(II), Fe(II-III) and/or Fe(III) oxides, or a combination of such iron sources. The CO₂ source may be a CO₂ gas, solid CO₂ or a CO₂ precursor, such as a carbonic acid or combination of a carbonate or a bicarbonate with an acid.

According to a first aspect, there is provided a process comprising contacting water, an iron-containing material, and a CO₂ source selected from the group consisting of CO₂ and a CO₂ precursor in a reactor, wherein the process further comprises contacting nitrogen (N₂) with the water, the iron-containing material, and the CO₂ source, or with a reaction product thereof in a reactor thereby producing NH₃, wherein the process is performed at a temperature of about 290° C. or less in the absence of electric energy. According to some embodiments, the step of contacting water, an iron-containing material, and a CO₂ source is resulting in a spontaneous reaction. According to some embodiments, the step of contacting nitrogen, water, an iron-containing material, and a CO₂ source is resulting in a spontaneous reaction. According to some embodiments, the step of contacting nitrogen and a reaction product of water, an iron-containing material, and a CO₂ source is resulting in a spontaneous reaction.

According to a second aspect, there is provided a process for producing NH₃, the process comprising contacting water, an iron-containing material, nitrogen (N₂) and a CO₂ source selected from the group consisting of CO₂ and a CO₂ precursor in a reactor thereby producing NH₃, wherein the process is performed in a single step in a closed reactor. According to some embodiments, the single step is resulting in a spontaneous reaction.

The reaction of the present invention may be conducted, according to some embodiments, sequentially by contacting the water, the iron-containing material, and the CO₂ source to produce an intermediate reaction mixture, which comprises hydrogen; and then adding nitrogen to the reaction mixture to produce ammonia.

According to some embodiments, the reaction may be conducted simultaneously by contacting the water, the iron-containing material, the CO₂ source with the nitrogen to produce a reaction product mixture containing ammonia.

It is to be understood that ammonia and water may be present together in an equilibrium with ammonium hydroxide (NH₄OH) at standard conditions. It is further to be understood by the skilled in the art that upon formation of ammonia at different stages of the reaction, water may still be present. Therefore, the phrase “thereby producing NH₃” refers to the production of ammonia, a salt thereof, or a mixture of ammonia and an ammonium salt. It is further to be understood the presence of acid(s) in the reaction mixture (including, but not limited to, Brønsted acid, e.g. HCl, and Lewis acid, e.g. high valent metals) as detailed below, may influence the final form in which ammonia is produced. Thus, the phrase “thereby producing NH₃” also includes, in addition to NH₄OH, a non-hydroxide salt of ammonia, metal-ammonia complex or a metal-ammonium complex.

As used herein, the term “contacting” is intended to mean bringing together reactants in a reaction (e.g., water, the iron-containing material, the CO₂ source, and nitrogen; or nitrogen and the reaction products of water, the iron-containing material, and the CO₂ source) to form a mixture, which may be homogeneous or heterogeneous with each possibility representing a separate embodiment. According to some embodiments, the contacting of water, the iron-containing material, and the CO₂ source entails forming a heterogenic mixture. According to some embodiments, the contacting of nitrogen, water, the iron-containing material, and the CO₂ source entails forming a heterogenic mixture. According to some embodiments, the contacting of nitrogen and the reaction products of water, the iron-containing material, and the CO₂ source entails forming a heterogenic mixture.

Specifically, the iron-containing material and nitrogen are typically water insoluble and the CO₂ source may differ in the degree of aqueous solubility depending on its identity and reaction conditions, e.g., the reaction pressure, temperature, and pH. Thus, since, according to some embodiments, at least one of the reaction constituents is insoluble, the resulting mixture is typically heterogenic. The term “contacting”, therefore, refers to dispersing, suspending and/or dissolving the CO₂ source and the iron-containing material in the water, optionally with mixing.

The term “simultaneous” reaction, as used herein, refers to more than one chemical transformation occurring in a single step, i.e., in one pot. As used herein, the term refers to the addition of all reactants substantially at the same time to form the reaction(s).

The term “sequential” reaction, as used herein, refers to a process involving more than one step, wherein each subsequent step is performed a certain time period following the initiation of its preceding step and each step involving at least one chemical transformation. It is to be understood that any subsequent step can be performed during the performance of the preceding step as long as a certain time period after initiation of the preceding step has passes or upon substantial completion of the preceding step. Each possibility represents a separate embodiment.

The term “nitrogen”, unless specified otherwise, is used herein to refer to elemental nitrogen as found in nature, i.e., dinitrogen, N₂. The term “nitrogen” is not limited to the gas phase of this element and is also referring to its liquid phase.

According to some embodiments, the water is in a liquid form. According to other embodiments, the iron-containing material is water insoluble. It is to be understood that N₂ is water insoluble.

The term “water insoluble”, as used herein, refers to a material, which has an aqueous solubility of not more than 10 gr/L, preferably, not more than 5 gr/L, 1 gr/L, gr/L, or 0.1 gr/L. Each possibility represents a separate embodiment.

According to some embodiments, upon contacting the iron-containing material and the water, an aqueous suspension is formed.

The term “suspension”, as used herein, refers to a heterogeneous mixture of a solid and a liquid in which the solid particles are not soluble and sufficiently large for sedimentation. The particles may be visible to the naked eye, and are usually larger than one micrometer. For example, when dispersing a water insoluble iron powder and carbon dioxide in water, the iron particles are not sufficiently soluble to form a solution, thereby forming a suspension. The term “suspending”, as used herein, refers to contacting two or more materials to form a suspension.

According to some embodiments, the mixture of the iron-containing material and the water is a viscous suspension. Specifically, it is to be understood that increasing the weight ratio of iron to water should increase the solid content and thereby also increase the viscosity of the suspension. According to some embodiments, the weight ratio between the iron-containing material and the water is at least 1:4. It is to be understood that the phrase “the weight ratio between the iron-containing material and the water is at least 1:4” refers to one gram, or more than one gram of the iron-containing material per each four grams of the water. According to other embodiments, the weight ratio between the iron-containing material and the water is at least 1:3. According to additional embodiments, the weight ratio between the iron-containing material and the water is at least 1:2. According to further embodiments, the weight ratio between the iron-containing material and the water is at least 1:1.5.

According to some embodiments, the process is performed at a temperature of about 290° C. or less. According to some embodiments, the process is performed at a temperature of about 270° C. or less. According to some embodiments, the process is performed at a temperature of about 250° C. or less. According to some embodiments, the process is performed at a temperature of about 230° C. or less. According to some embodiments, the process is performed at a temperature of about 210° C. or less. According to some embodiments, the process is performed at a temperature of about 200° C. or less. According to some embodiments, the process is performed at a temperature of about 180° C. or less. According to some embodiments, the process is performed at a temperature of about 170° C. or less. According to some embodiments, the process is performed at a temperature of about 160° C. or less. According to some embodiments, the process is performed at a temperature of about 150° C. or less. According to some embodiments, the process is performed at a temperature of about 140° C. or less. According to some embodiments, the process is performed at a temperature of about 130° C. or less. According to some embodiments, the process is performed at a temperature of about 120° C. or less. According to some embodiments, the process is performed at a temperature of about 110° C. or less. According to some embodiments, the process is performed at a temperature of about 100° C. or less. According to some embodiments, the process is performed at a temperature of about 90° C. or less. According to some embodiments, the process is performed at a temperature of about 80° C. or less. According to some embodiments, the process is performed at a temperature of about 70° C. or less. According to some embodiments, the process is performed at a temperature of about 60° C. or less. According to some embodiments, the process is performed at a temperature of about 50° C. or less. According to some embodiments, the process is performed at a temperature of about or less. According to some embodiments, the process is performed at a temperature of about 35° C. or less. According to some embodiments, the process is performed at a temperature of about 30° C. or less.

It is to be understood that in order to regulate the reaction rate, various conditions, such as, temperatures, pH and pressure may be modified during the reaction progression in any one of its steps.

According to some embodiments, the process is performed in the absence of external thermal energy. According to some embodiments, the process is performed in the absence of electric energy (i.e., in the absence of an electrolysis step). According to some embodiments, the process is performed in the absence of any one of external thermal energy and electric energy.

According to some embodiments, the reactions of the present invention are characterized by (a) being performed without supplying external heat or electric energy to the reaction and/or (b) being performed in a single step reaction. The present invention thus provides, according to some embodiments, a spontaneous and/or single step process by which ammonia can be obtained.

According to some embodiments, any one of the steps of contacting or mixing is individually performed at a temperature in the range of −30° C. and 290° C., including each value within the specified range. According to some embodiments, any one of the steps of contacting or mixing is individually performed at a temperature in the range of −5° C. and 290° C., including each value within the specified range. It is to be understood that by “any one of the steps of contacting or mixing is individually performed” it is meant that one or more of following steps: (i) contacting water, an iron-containing material, and a CO₂ source; (ii) contacting nitrogen, water, an iron-containing material, and a CO₂ source; and/or (iii) contacting nitrogen with the reaction products of water, an iron-containing material, and a CO₂ source; including the combination of steps (i) and (iii), may be performed as further described. Thus, any one of steps 1a-2a and 1b as detailed below may be separately performed at a temperature in the range of −30° C. and 290° C., in the range of −5° C. and 290° C., in the range of −5° C. and 100° C., or in the range of 100° C. and 290° C., including each value within the specified ranges. Further reference in this paragraph is made to the selected step(s). According to other embodiments, the step of contacting is performed at a temperature in the range of −5° C. and 250° C., including each value within the specified range.

According to other embodiments, the step of contacting is performed at a temperature in the range of −5° C. and 200° C., including each value within the specified range. According to other embodiments, the step of contacting is performed at a temperature in the range of −5° C. and 150° C., including each value within the specified range. According to other embodiments, the step of contacting is performed at a temperature in the range of −5° C. and 125° C., including each value within the specified range. According to other embodiments, the step of contacting is performed at a temperature in the range of −5° C. and 90° C., including each value within the specified range. According to other embodiments, the step of contacting is performed at a temperature in the range of −5° C. and 80° C., including each value within the specified range. According to yet other embodiments, the step of contacting is performed at a temperature in the range of −5° C. and 50° C., including each value within the specified range. According to particular embodiments, the step of contacting is performed at a temperature in the range of 0° C. and 45° C., including each value within the specified range. According to specific embodiments, the step of contacting is performed at a temperature in the range of 5° C. and 40° C., including each value within the specified range. According to some embodiments, the process is performed at a temperature of 100° C. or less. According to some embodiments, the process is performed at a temperature of 95° C. or less. According to some embodiments, the process is performed at a temperature of 90° C. or less. According to some embodiments, the process is performed at a temperature of 85° C. or less. According to some embodiments, the process is performed at a temperature of 80° C. or less. According to some embodiments, the process is performed at a temperature of 75° C. or less. According to some embodiments, the process is performed at a temperature of 70° C. or less. According to some embodiments, the process is performed at a temperature of 65° C. or less. According to some embodiments, the process is performed at a temperature of 60° C. or less. According to some embodiments, the process is performed at a temperature of 55° C. or less. According to some embodiments, the process is performed at a temperature of 50° C. or less.

According to some embodiments, the process is performed in the absence of external heating. It is to be understood that the phrase “in the absence of external heating” is intended to exclude delivery of heat to the reaction mixture, which is other than spontaneous heat formed upon the progression of the reaction. Specifically, the reaction of the current process is mildly exothermic. Thus, upon the progression of the reaction to form ammonia, the internal temperature inside a closed reactor is raised spontaneously. Such elevation of temperature is not considered external heating and is therefore not excluded by the phrases “in the absence of external heating”, “without external heating”, “the process does not include external heating” and related phrases. Rather, these phrases are intended to exclude providing additional heating from an external source, such as by an electronic heating element or a burner. Thus, in accordance with these embodiments, the process is devoid of heating the reaction mixture. As used herein, the process is a spontaneous process. The term “spontaneous process” as used herein, refers to a process that does not utilize an external energy. The phrases “in the absence of external energy”, “wherein no further energy is added to the reaction”, and “without the addition of external energy” are intended to describe a process that occurs without an energy input from an outside source such as heating, irradiation and supply of electricity. It is to be understood that “irradiation”, as used herein, refers to application of external electromagnetic radiation, such as UV radiation, IR radiation, visible-range radiation, including sunlight radiation, microwave radiation, radio radiation, X-ray radiation and gamma radiation. According to some embodiments, the process is performed in the absence of light. It is to be understood that an endogenous elevation of temperature of the reaction mixture may occur, and is not excluded by the phrases “in the absence of external heating”, “without external heating”, “the process does not include external heating” and related phrases. Specifically, such endogenous elevation of temperature may result, e.g., from the changing of the pressure inside the closed reactor, in which the reaction takes place or from energy exerted by the dissolution of material in the water. Specifically, throughout the reaction of the process of the current invention, CO₂ as a CO₂ gas and/or N₂ as a N₂ gas may be supplemented which may result in an elevation of the pressure in the reactor. Also, according to some embodiments, H₂ gas may evolve, which elevates the gas pressure inside the reactor. Furthermore, most dissolution processes are exothermic, meaning that upon the formation of a solution from the solvent and the solute (e.g. from water and carbon dioxide or from water and ammonia) the temperature may rise. This is an additional endogenous heating, which is not excluded by the definitions presented above. An additional factor which may slightly affect the reaction temperature and is not excluded by the phrases above is the mixing, stirring or blending of the reaction contents. Specifically, these mixing processes may result in a slight elevation of temperature due to the kinetic energy they discharge, but are not considered to provide external heating according to the definition of the current invention. It is further to be understood that employment of reaction catalyst(s), initiator(s) or promoter(s) does not exclude a reaction from being considered spontaneous, as these facilitate the kinetics of the reaction, but do not affect the net thermodynamics.

According to some embodiments, the step of contacting water, an iron-containing material, nitrogen and a CO₂ source is performed in the absence of external thermal energy. According to some embodiments, the step of contacting water, an iron-containing material, nitrogen and a CO₂ source is performed in the absence of external electric energy. According to some embodiments, the step of contacting water, an iron-containing material, nitrogen and a CO₂ source is performed in the absence of external radiant energy. According to some embodiments, the step of contacting water, an iron-containing material, nitrogen and a CO₂ source is performed in the absence of external energy. According to some embodiments, the step of contacting water, an iron-containing material, and a CO₂ source is performed in the absence of external thermal energy. According to some embodiments, the step of contacting water, an iron-containing material, and a CO₂ source is performed in the absence of external electric energy. According to some embodiments, the step of contacting water, an iron-containing material, and a CO₂ source is performed in the absence of external radiant energy. According to some embodiments, the step of contacting water, an iron-containing material, and a CO₂ source is performed in the absence of external energy. According to some embodiments, the step of contacting hydrogen and nitrogen is performed in the absence of external thermal energy. According to some embodiments, the step of contacting hydrogen and nitrogen is performed in the absence of external electric energy. According to some embodiments, the step of contacting hydrogen and nitrogen is performed in the absence of external radiant energy. According to some embodiments, the step of contacting hydrogen and nitrogen is performed in the absence of external energy. According to some embodiments, step (1b) is performed in the absence of external thermal energy. According to some embodiments, step (1b) is performed in the absence of external electric energy. According to some embodiments, step (1b) is performed in the absence of external radiant energy. According to some embodiments, step (1b) is performed in the absence of external energy. According to some embodiments, step (1a) is performed in the absence of external thermal energy.

According to some embodiments, step (1a) is performed in the absence of external electric energy. According to some embodiments, step (1a) is performed in the absence of external radiant energy. According to some embodiments, step (1a) is performed in the absence of external energy. According to some embodiments, step (2a) is performed in the absence of external thermal energy. According to some embodiments, step (2a) is performed in the absence of external electric energy. According to some embodiments, step (2a) is performed in the absence of external radiant energy. According to some embodiments, step (2a) is performed in the absence of external energy. Steps (1a), (1b) and (2b), including sub-steps thereof are detailed herein below.

According to some aspects and embodiments, the process disclosed herein is performed in a closed reactor. As used herein, the term “closed reactor” refers to a closed system which at least temporarily isolates the reaction mixture contained therein from the surrounding environment and allows build-up of gas pressure by preventing material from departing its enclosure. It is to be understood that closed reactors may include opening(s) and/or a cover, for gaining access to the reaction medium therein, and are not limited to permanently sealed or closed structures. Elements, such as a cover or a port may provide reversible access to the interior of the reactor, such that its closed feature may be limited to the operation period thereof. The reactor may possess any shape including, but not limited to, cylindrical, cubical, and rectangular shapes, and may be composed of a variety of materials including, but not limited to, metals, plastics and ceramics. According to some embodiments, the reactor is equipped with a mixing mechanism. The mixing mechanism may be based on a mechanical, a magnetic, an ultrasonic, and a high-pressure liquid mixer as is known in the art. According to some embodiments, the reactor contents are mixed by circulating and/or recirculating the reaction mixture by continuous or intermittent flow. The flow can be generated by a pump, such as a high-pressure pump, functionally associated with the reactor.

According to some embodiments, the contacting of the water, the iron-containing material, the nitrogen and the CO₂ source is performed in a single step in a closed reactor.

By the phrase “performed in a single step in a closed reactor” it is meant that the nitrogen, the water, the iron-containing material, and the CO₂ source are added to the reactor, when its opening(s) (e.g., via a gas valve, or the cover) allow insertion of reactants, and the reactor is then closed to allow the reaction.

According to some embodiments, the process comprises the steps of:
(1b) placing the water, the iron-containing material, the nitrogen and the CO₂ source in the closed reactor in a closed process environment, thereby producing NH₃; and
(2b) collecting the produced NH₃.

According to some embodiments, step (1b) is resulting in a spontaneous reaction. Without wishing to be bound by any theory or mechanism of action, upon the contacting of the iron-containing material, the water and the CO₂ source, hydrogen (H₂) is formed in situ. It is further hypothesized that the hydrogen formed in situ is reacting with the nitrogen found in the reactor, in the presence of the iron-containing material, which acts as a catalyst, and of CO₂ source, which act as a regulator, to form ammonia in a single step reaction. According to some embodiments, the contacting of the water, the iron-containing material, and the CO₂ source entails producing hydrogen, wherein the hydrogen is reacting with the nitrogen in the presence of the iron-containing material and carbon dioxide, to produce ammonia.

According to some embodiments, in step (1b) the water and the iron-containing material are placed in the reactor before the nitrogen and the CO₂ source. According to some embodiments, water is added first and the iron-containing material is dispersed therein. According to some embodiments, the iron-containing material is added first and water is added thereto. According to some embodiments, the CO₂ source and the nitrogen are added simultaneously. According to some embodiments, the CO₂ source comprises CO₂ gas, wherein the CO₂ gas and the nitrogen are added simultaneously. According to some embodiments, the CO₂ source is added before the addition of nitrogen. According to some embodiments, the CO₂ source is selected from dry ice and a CO₂ precursor, and is added before the addition of nitrogen. According to some embodiments, the nitrogen is added to the reactor last. According to some embodiments, the CO₂ source is dry ice and the iron-containing material is dispersed therein.

According to some embodiments, the CO₂ source is dry ice provided in a form selected from the group consisting of dry ice blocks, dry ice pellets, dry ice granules or a combination thereof, wherein the iron-containing material is provided in the form of a powder and is contacted with the dry ice of form a dispersion. According to some embodiments, the iron containing material is injected into the dry ice blocks, dry ice pellets, dry ice granules or a combination thereof using a powder injector.

According to some embodiments, the process comprises (1bⁱ) dispersing an iron-containing material in water; (1bⁱⁱ) adding a CO₂ source to the dispersion of step (1bⁱ); and (2b) adding nitrogen to the dispersion of step (1bⁱⁱ) thereby generating a reaction. In other embodiments, the process comprises (1bⁱⁱⁱ) supplementing CO₂ from a CO₂ source to the water; (1b^{iv}) adding an iron-containing material to the water supplemented with CO₂ of step (1bⁱⁱⁱ); and (1b^{v}) adding nitrogen to the mixture of step (1b^{iv}) thereby generating a reaction.

According to some embodiments, step (1b^{iv}) further comprises mixing the reaction mixture.

According to some embodiments, step (1bⁱ) of dispersing an iron-containing material in water, may be performed inside the closed reactor.

According to some embodiments, the CO₂ source and the iron-containing material are added substantially simultaneously to the water, inside the closed reactor and the formed mixture is maintained substantially sealed in the closed reactor for a period of time. According to some embodiments, the process further comprises mixing the mixture formed upon the addition.

According to some embodiments, the process comprises the steps of:
(1bⁱ) dispersing the CO₂ source in water;
(1bⁱⁱ) adding the iron-containing material to the dispersion of step (1bⁱ);
(2b) adding nitrogen to the dispersion of step (1bⁱⁱ); and
(3b) maintaining the mixture of step (2b) substantially sealed in the closed reactor for a period of time.

According to some embodiments, step (1bⁱ), of dispersing the CO₂ source in water comprises at least partially solubilizing a CO₂ source in the water. According to some embodiments, step (2b) further comprises mixing the mixture formed in step (1bⁱⁱ). According to the principles of the present invention, steps (1bⁱ) and (1bⁱⁱ) can be performed in an open setting or in a closed reactor with each possibility representing a separate embodiment.

According to some embodiments, the process is a two-step reaction comprising the steps of:
(1a) placing the water, the iron-containing material and the CO₂ source in a reactor, thereby producing H₂; and
(2a) adding the nitrogen to the reactor, wherein the nitrogen is contacting the produced H₂, to produce NH₃.

According to some embodiments, step (1a) is resulting in a spontaneous reaction. According to some embodiments, step (2a) is performed in the presence of the iron-containing material. According to some embodiments, step (2a) is performed in the presence of the water. According to some embodiments, step (2a) is performed in the presence of the CO₂ source. According to some embodiments, step (2a) is performed in the presence of at least one of: the iron-containing material, the water and the CO₂ source. According to some embodiments, step (2a) is performed in the presence of at least two of: the iron-containing material, the water and the CO₂ source. According to some embodiments, step (2a) is performed in the presence of each one of: the iron-containing material, the water and the CO₂ source. According to some embodiments, step (2a) further comprises the addition at least one of the iron-containing material, the water and the CO₂ source to the reactor. According to some embodiments, step (2a) is resulting in a spontaneous reaction.

According to some embodiments, the process further comprises step (3a) of collecting the produced NH₃.

According to some embodiments, the process comprises: (1aⁱ) dispersing an iron-containing material in water; (1aⁱⁱ) adding a CO₂ source to the dispersion of step (1aⁱ) thereby generating a reaction; and (2a) adding nitrogen to the reaction mixture of step (1aⁱⁱ) thereby generating a second reaction to produce ammonia. Without wishing to be bound by any theory or mechanism of action, upon the first reaction, involving the iron-containing material, the water and the CO₂ source, hydrogen (H₂) is formed. It is further hypothesized that the hydrogen formed in the first reaction is reacting with nitrogen in the presence of the iron-containing material, which act in the second reaction as a catalyst, and CO₂ source, which act as a regulator, to form ammonia in a two-step reaction.

In other embodiments, the process comprises (1a^{iv}) supplementing CO₂ from a CO₂ source to the water; (1a^{v}) adding an iron-containing material to the water supplemented with CO₂ of step (1a^{iv}) thereby generating a reaction; and (2a) adding nitrogen to the reaction mixture of step (1a^{v}) thereby generating another reaction and producing ammonia.

According to some embodiments, the process comprises the steps of:
(1aⁱ) dispersing an iron-containing material in water;
(1aⁱⁱ) adding a CO₂ source to the dispersion of step (1aⁱ);
(1aⁱⁱⁱ) maintaining the mixture of step (1aⁱⁱ) substantially sealed in the closed reactor for a period of time; and
(2a) adding nitrogen to the mixture of step (1aⁱⁱⁱ) thereby producing ammonia.

According to some embodiments, the process comprises the steps of:
(1aⁱ) dispersing an iron-containing material in water;
(1aⁱⁱ) adding a CO₂ source to the dispersion of step (1aⁱ);
(1aⁱⁱⁱ) maintaining the mixture of step (1aⁱⁱ) substantially sealed in the closed reactor for a period of time;
(2b) adding nitrogen to the mixture of step (1aⁱⁱⁱ); and
(2b′) maintaining the mixture of step (2b) substantially sealed in the closed reactor for a second period of time thereby producing ammonia.

According to the principles of the present invention, step (1aⁱ) may comprise dispersing an iron-containing material in water in an open setting and transferring the dispersion to the closed reactor.

According to some embodiments, step (1aⁱⁱⁱ) further comprises mixing the mixture formed in step (1aⁱⁱ). According to some embodiments, step (2bⁱ) further comprises mixing the mixture formed in step (2b).

According to some embodiments, step (1aⁱ) of dispersing an iron-containing material in water, may be performed inside the closed reactor.

According to some embodiments, the CO₂ source and the iron-containing material are added substantially simultaneously to the water, inside the closed reactor and the formed mixture is maintained substantially sealed in the closed reactor for a period of time. According to some embodiments, the process further comprises mixing the mixture formed upon the addition.

According to some embodiments, the process comprises the steps of:
(1a^{iv}) adding the CO₂ source in water;
(1a^{v}) adding the iron-containing material to the dispersion of step (1a^{iv});
(1aⁱ) maintaining the mixture of step (1a^{v}) substantially sealed in the closed reactor for a period of time; and
(2a) adding nitrogen to the mixture of step (1aⁱ) thereby producing ammonia.

According to some embodiments, the process comprises the steps of:
(1a^{iv}) adding the CO₂ source in water;
(1a^{v}) adding the iron-containing material to the dispersion of step (1a^{iv});
(1aⁱ) maintaining the mixture of step (1a^{v}) substantially sealed in the closed reactor for a period of time;
(2a) adding nitrogen to the mixture of step (1aⁱ) thereby producing ammonia; and
(2aⁱ) maintaining the mixture of step (2a) substantially sealed in the closed reactor for a second period of time thereby producing ammonia.

According to some embodiments, step (1a^{iv}), of dispersing the CO₂ source in water comprises at least partially solubilizing a CO₂ source in the water. According to some embodiments, step (1aⁱ) further comprises mixing the mixture formed in step (1a^{v}). According to the principles of the present invention, steps (1a^{iv}) and (1a^{v}) can be performed in an open setting or in a closed reactor with each possibility representing a separate embodiment.

According to some embodiments, performing step (1a) entails initiating a chemical reaction to produce H₂. According to some embodiments, performing step (2a) entails initiating a chemical reaction to produce NH₃. According to some embodiments, the reaction conditions of the chemical reaction of step (1a) are substantially similar to the reaction conditions of the chemical reaction of step (2a).

According to some embodiments, the reaction conditions of the chemical reaction of step (1a) are substantially different from the reaction conditions of the chemical reaction of step (2a). Reaction conditions include, but are not limited to: reaction temperature, reaction pH and reaction gas pressure. According to some embodiments, the chemical reaction of step (1a) is performed at a lower temperature than the chemical reaction of step (2a). According to some embodiments, the chemical reaction of step (1a) is performed at a lower gas pressure than the chemical reaction of step (2a).

One of the advantages of the current process is that the ammonia produced thereby is of high purity and is substantially devoid of contaminants, which are incompatible with fuels and combustion. According to some embodiments, the ammonia produced by the present process is produced at a purity of at least 85%. According to some embodiments, the ammonia produced by the present process is produced at a purity of at least 90%. According to some embodiments, the ammonia produced by the present process is produced at a purity of at least 95%. According to some embodiments, the ammonia produced by the present process is produced at a purity of at least 97%. According to some embodiments, the ammonia produced by the present process is produced at a purity of at least 98%. According to some embodiments, the ammonia produced by the present process is produced at a purity of at least 99%. According to some embodiments, the ammonia produced by the present process is produced at a purity of at least 99.5%.

As detailed herein, hydrogen is formed upon the reaction of the water, the CO₂ source and the iron-containing material. According to some implementations of the present invention it may be beneficial to produce an ammonia-hydrogen mixture. According to some embodiments, the process comprises contacting water, an iron-containing material, and a CO₂ source selected from the group consisting of CO₂ and a CO₂ precursor or a reaction product thereof with nitrogen (N₂) in the reactor thereby producing a mixture of NH₃ and H₂. According to some embodiments, the process comprises contacting water, an iron-containing material, nitrogen (N₂) and a CO₂ source selected from the group consisting of CO₂ and a CO₂ precursor in a reactor thereby producing a mixture of NH₃ and H₂.

According to some embodiments, the process further comprises collecting the mixture of NH₃ and H₂. According to some embodiments, the process further comprises separating the NH₃ and H₂ and collecting the NH₃ and H₂.

According to some embodiments, the mixture of NH₃ and H₂ comprises at least 1% H₂ w/w. According to some embodiments, the mixture comprises at least 2% H₂ w/w. According to some embodiments, the mixture comprises at least 3% H₂ w/w. According to some embodiments, the mixture comprises at least 4% H₂ w/w. According to some embodiments, the mixture comprises at least 5% H₂ w/w. According to some embodiments, the mixture comprises at least 8% H₂ w/w. According to some embodiments, the mixture comprises at least 10% H₂ w/w. According to some embodiments, the mixture comprises at least 15% H₂ w/w. According to some embodiments, the mixture comprises at least 20% H₂ w/w. According to some embodiments, the mixture comprises at least 25% H₂ w/w. According to some embodiments, the mixture comprises at least 30% H₂ w/w. According to some embodiments, the mixture comprises at least 40% H₂ w/w. According to some embodiments, the mixture comprises at least 50% H₂ w/w.

According to some embodiments, the mixture of NH₃ and H₂ comprises at least 30% NH₃ w/w. According to some embodiments, the mixture of NH₃ and H₂ comprises at least 40% NH₃ w/w. According to some embodiments, the mixture of NH₃ and H₂ comprises at least 50% NH₃ w/w. According to some embodiments, the mixture of NH₃ and H₂ comprises at least 60% NH₃ w/w. According to some embodiments, the mixture of NH₃ and H₂ comprises at least 70% NH₃ w/w. According to some embodiments, the mixture of NH₃ and H₂ comprises at least 80% NH₃ w/w. According to some embodiments, the mixture of NH₃ and H₂ comprises at least 90% NH₃ w/w. According to some embodiments, the mixture of NH₃ and H₂ comprises at least 95% NH₃ w/w. According to some embodiments, the mixture of NH₃ and H₂ comprises at least 97% NH₃ w/w. According to some embodiments, the mixture of NH₃ and H₂ comprises at least 99% NH₃ w/w.

According to some embodiments, the process further comprises a step of collecting the produced NH₃. According to some embodiments, collecting the produced NH₃ comprises delivering the NH₃ in a gas form to a gas container through a gas pipe. According to some embodiments, the gas pipe is extending from the closed reactor to the gas container. According to some embodiments, the gas pipe comprises a valve configured to allow the closed reactor to be sealed during the period of time during which reaction occurs. According to some embodiments, the gas pipe comprises a valve configured to allow the closed reactor to be sealed during the period of time of any one of steps (1a), (2a), (1b), including any one of (1a^{x}), (2aₓ), (1b^{x}), as detailed herein. According to some embodiments, the gas valve is configured to allow passage of NH₃ gas from the closed reactor to a gas container thereby collecting the produced NH₃. According to some embodiments, the gas valve is configured to allow passage of NH₃ gas from the closed reactor to the gas container in the step of collecting the produced NH₃. In some embodiments, the release system comprises a valve (such as a reverse valve) with a flame retardant or bubbler attached.

According to some embodiments, NH₃ is collected as a liquid. According to some embodiments, NH₃ is collected as a solution. According to some embodiments, NH₃ is collected as an aqueous solution. According to some embodiments, the process further comprises adding water to the reaction mixture comprising the NH₃, to form an aqueous ammonia solution, and collecting the aqueous ammonia solution. As detailed above, it is understood that an aqueous ammonia solution contains ammonia in the form of ammonium hydroxide NH₄OH.

According to some embodiments, the process further comprises the steps of treating the produced NH₃. According to some embodiments, the treatment step is selected from a group consisting of separation, de-humidification and pH neutralization. Each possibility represents a separate embodiment. According to some embodiments, the treatment comprises separating gases other than NH₃ from the NH₃ gas that is formed. It is to be understood that other gasses may be present after the reaction completion, such as hydrogen, CO₂, water vapor, gasses present in atmospheric air, etc. NH₃ released from the closed reactor can therefore be passed via a gas separation or filtration system, according to some embodiments.

According to some embodiments, the process further entails producing an iron oxide which can then be collected.

According to some embodiments, the iron oxide produced in the process comprises at least one of iron (II) oxide (FeO), iron (II,III) oxide (Fe₃O₄), iron (III) oxide (Fe₂O₃), and combinations thereof. According to some embodiments, the iron oxide produced in the process is selected from the group consisting of iron (II) oxide (FeO), iron (II,III) oxide (Fe₃O₄), iron (III) oxide (Fe₂O₃), and combinations thereof. In other embodiments, the iron oxide produced in the process is selected from the group consisting of iron (II) oxide (FeO), iron (II,III) oxide (Fe₃O₄), and combinations thereof. According to some embodiments, the iron oxide produced in the process comprises iron (II) oxide. According to some embodiments, the iron oxide produced in the process is iron (II) oxide.

It was surprisingly found that the process of the current invention is suited for the production of high purity iron (II) oxide. As high purity iron (II) oxide is a valuable compound, it is an advantage of the current invention to isolate the formed iron (II) oxide.

According to some embodiments, the process further comprises a step of collecting the produced iron oxide. According to some embodiments, the process further comprises step (4a) of collecting the produced iron oxide. According to some embodiments, the process further comprises step (3b) of collecting the produced iron oxide. According to some embodiments, the process further comprises a step of collecting the produced iron (II) oxide.

According to some embodiments, the process further entails producing an iron carbonate, which can then be collected.

The tem′ “iron carbonate”, as used herein refers to any compound comprising at least one iron atom, at least one carbon atom and at least one oxygen atom, wherein each carbon atom is covalently bound to 3 oxygen atoms, and each iron atom is surrounded by at least one carbonate ion.

According to some embodiments, the iron carbonate produced in the process comprises at least one of iron (II) carbonate (FeCO₃), FeOHCO₃, Fe(OH)₂CO₃, (Fe(OH)₂)₂CO₃, and combinations thereof. Each possibility represents a separate embodiment. According to some embodiments, the iron carbonate produced in the process is selected from the group consisting of FeCO₃, FeOHCO₃, Fe(OH)₂CO₃, (Fe(OH)₂)₂CO₃, and combinations thereof. Each possibility represents a separate embodiment. In other embodiments, the iron produced in the process comprises a combination of an iron oxide and an iron carbonate as described herein.

According to certain aspects and embodiments, the process of the present invention utilizes nitrogen, water, an iron-containing material, and a CO₂ source as the reactants in the process. Advantageously, the reactants can be obtained from various sources, including waste, without the need for purification, pre-treatment or pre-processing. Nonetheless, it is to be understood that each of the reactants can be purified, pre-treated or pre-processed prior to being used in the process of the present invention.

The term “Water” as used herein refers to any type of an aqueous medium including, but not limited to, tap water, sea water, partially purified water, deionized water, distilled water, brackish water and waste water. Each possibility represents a separate embodiment. According to some embodiments, the water is non-purified water. In certain embodiments, the water is selected from the group consisting of tap water, sea water, partially purified water, deionized water, distilled water, brackish water, and waste water. Each possibility represents a separate embodiment.

As used herein, the term “sea water” refers to saline water obtained from a sea or an ocean. Ion concentration in sea water is usually from about 10,000 ppm to about 44,000 ppm, including each value within the specified range. Common ions in seawater are chloride, sodium, sulfate, magnesium, calcium, potassium, bicarbonate, strontium, bromide, borate, fluoride, boron, silicate, and iodide.

As used herein, the term “brackish water” refers to water that has a higher salinity as compared to fresh water, but a lower salinity as compared to sea water. Brackish water typically has at least 0.5 grams per liter of dissolved salts. The term “brackish water” can also encompass saline water.

As used herein, the term “deionized water” refers to water that has had almost all of its mineral ions removed, including cations such as sodium, calcium, iron, and copper, and anions such as chloride and sulfate. Deionization is a chemical process that uses specially manufactured ion-exchange resins, which reduce the amount of minerals by exchanging them with hydrogen and hydroxides.

As used herein, the term “distilled water” refers to water that is produced by a process of distillation. Distillation involves boiling the water and then condensing the vapor into a clean container, leaving solid contaminants behind.

The term “waste water” as herein used refers to residential, domestic, commercial and/or industrial liquid waste comprising organic or inorganic material. Usually, the term is used to define aqueous waste containing biological material, for example, one or more of sewage material, storm water and grey water such as, for example, laundry and/or bathroom waste also referred to as sullage. The term “waste water” as used herein also encompasses non-biological and inorganic aqueous waste material, such as water used for cleaning or temperature regulating of industrial machinery. It is to be understood that using waste water for various purposes is both economically and environmentally beneficial, as this type of water would otherwise require rigorous purification process(es) in order to be recycled as useful water. According to some embodiments, the water used in the present process comprises waste water.

According to some embodiments, the water of the present process is in a liquid or semi-liquid state. According to some embodiments, the water of the present process is in the liquid state. According to some embodiments, the water of the present process is in the liquid phase. According to some embodiments, the water is in the liquid state throughout the reaction.

The term “iron-containing material”, as used herein refers to any element, alloy, compound or complex, which contains iron atoms. The term is not excluded to certain iron compounds and alloys or elemental iron, and further encompasses mixtures of iron element, alloy, compound or complex with other element(s), alloy(s), compound(s) or complex(es), which contain elements other than iron. For example, a mixture of steel and nickel is included in the definition of the term “iron-containing material”, as steel contains iron. Furthermore, many ores contain, in addition to iron, other metals, such as zinc, copper, lead, vanadium, gold and the like, such ores are also iron-containing materials according to the principles of the present invention. In one embodiment, the iron-containing material is a coal-combustion product.

According to some embodiments, the iron-containing material is a material containing a significant percentage of iron, for example more than 5%, more than 10% more than 20%, more than 30%, more than 40%, more than 50%, more than 60%, more than 70%, more than 80%, and even more than 90% by weight of iron. According to some embodiments, the iron species could be the base metallic iron (Fe⁰) or an iron compound. Each possibility represents a separate embodiment. According to some embodiments, the iron-containing material includes at least a Fe⁰ species. The iron compound may comprise iron as Fe⁰ such as in Fe(CO)₅, Fe(II) such as in FeO, Fe(III) such as in Fe₂CO₃, Fe(II,III) such as in Fe₃O₄ or a mixture of various other iron compounds, according to some embodiments. Additional iron compounds that can be used as reactants according to the principles of the present invention include, but are not limited to, FeCO₃, FeOHCO₃, Fe(OH)₂CO₃, and (Fe(OH)₂)₂CO₃. Each possibility represents a separate embodiment. The iron compound could also contain a mixture of different metal complexes, such as is found in ore, used metals or metal waste, according to some embodiments. The minimum iron concentration depends on the species contained in the compound used and its oxidation state. In various embodiments, the process further comprises recycling of iron waste thereby producing an iron oxide or iron carbonate. In various embodiments, the process further comprises recycling of iron waste thereby producing an iron oxide. In some embodiments, the process further comprises recycling of iron waste thereby producing iron carbonate. In further embodiments, the iron-containing material comprises iron waste.

According to some embodiments, the iron-containing material is selected from the group consisting of an iron metal, an iron alloy, an Fe⁰ complex, an iron oxide, an iron carbonate, and a mixture or combination thereof. Each possibility represents a separate embodiment. According to some embodiments, the iron-containing material is a base metal, a metal oxide or a combination thereof. According to some embodiments, the iron-containing material is a partially un-oxidized metal.

Iron alloys suitable for use as reactants according to the principles of the present invention include, but are not limited to, Elinvar, Fernico, Ferroalloy, Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, Ferrovanadium, Invar, Cast iron, Pig iron, Iron hydride, Kanthal, Kovar, Spiegeleisen, Staballoy and Steel, including, Bulat steel, Chromoly, Crucible steel, Damascus steel, Ducol, Hadfield steel, High speed steel, Mushet steel, HSLA steel, Maraging steel, Reynolds 531, Silicon steel, Spring steel, Stainless steel, AL-6XN, Alloy 20, Celestrium, Marine grade stainless, Martensitic stainless steel, Sanicro 28, Surgical stainless steel, Zeron 100, Tool steel, Silver steel, Weathering steel, and Wootz steel. Each possibility represents a separate embodiment.

According to some embodiments, the iron-containing material comprises Fe⁰. According to other embodiments, the iron-containing material is Fe⁰.

As used herein Fe⁰ and Fe(0) refers to iron in the zero oxidation state. Fe⁰-containing materials include iron metal (i.e. elemental iron), iron alloys, and Fe⁰ complexes. Each possibility represents a separate embodiment. In currently preferred embodiments, the iron-containing material comprises an iron metal.

According to some embodiments, the iron-containing material is provided in the form of a powder, shavings, bars, chips, or granules. Each possibility represents a separate embodiment. Typically, the iron-containing material is provided in the form of a powder. According to some embodiments, the iron-containing material is an iron metal provided in the form of a powder.

According to some embodiments, the process further comprises a step of grinding the iron-containing material to a powder. According to some embodiments, the process further comprises a step of grinding the iron metal to a powder. According to some embodiments, the step of grinding the iron-containing material to a powder is performed prior to the step of mixing or reacting the iron-containing material, the water and the CO₂ source. According to some embodiments, the step of grinding the iron metal to a powder is performed prior to the step of contacting the iron-containing material, the water and the CO₂ source.

According to some embodiments, the process further comprises a step of providing a non-powdered iron-containing material and grinding it to a powder, prior to mixing or reacting it with the water and the CO₂ source. According to some embodiments, the process further comprises a step of providing a non-powdered iron-containing material and grinding it to a powder, prior to dispersing it in the water or in the water supplemented with the CO₂ source.

According to some embodiments, the process further comprises a step of providing a non-powdered iron metal and grinding it to a powder, prior to mixing or reacting it with the water and the CO₂ source. According to some embodiments, the process further comprises a step of providing a non-powdered iron metal and grinding it to a powder, prior to dispersing it in the water or in the water supplemented with the CO₂ source.

Grinding, can be performed using any suitable method, e.g., milling, crushing, cutting, using any suitable device, e.g., vortex mill, jet mill, conical mill, ball mill, SAG mill, pebble mill, roller press, buhrstone mill, VSI mill, tower mill or combinations thereof. Each possibility represents a separate embodiment.

Typically, when the iron-containing material is in the form of a powder, the iron-containing material has a particle size of less than 100 μm, less than 50 μm, or less than 10 μm, with each possibility representing a separate embodiment. According to currently preferred embodiments, the iron-containing material is milled to a particle size in the range of 0.5-5 μm, including each value within the specified range. According to some embodiments, the iron-containing material has a particle size in the range of 1-5 μm, including each value within the specified range. According to some embodiments, the iron-containing material has a particle size in the range of 1.5-4.5 μm, including each value within the specified range. According to some embodiments, the iron-containing material has a particle size in the range of 2-4 μm, including each value within the specified range. According to some embodiments, the iron-containing material has a particle size in the range of 2.5-3.5 μm, including each value within the specified range.

When using iron metal as the iron-containing material, it was surprisingly found that under the current reaction conditions, it is not required to use purified material. More specifically, the reaction proceeds to form ammonia in high purity even when using iron waste. It was surprisingly found that iron-containing starting materials that can be used according to the principles of the present invention include iron slag (waste from the boiler of a coal fired power plant) and iron shavings collected from the metal working industry. Using iron waste provides dual advantages to the process of the present invention since it is an inexpensive starting material which is also recycled by the process of the present invention. Therefore, the process disclosed herein therefore further provides a beneficial environmental advantage.

According to some embodiments, the iron-containing material comprises iron-containing coal combustion product.

The term “iron-containing coal combustion product” as used herein includes, but is not limited to, iron-containing coal combustion wastes and iron-containing coal combustion residues selected from coal ash, fly ash, bottom ash, boiler slag, heavy oil ash and a mixture or combination thereof. Each possibility represents a separate embodiment. It can be originated from a power plant, a fuel boiler, or from cement production or other industrial thermal processes. Each possibility represents a separate embodiment. Iron-containing coal combustion products may also be produced by the combustion of other heavy fuel oils, e.g. mazut. Since the chemical composition of coal combustion products (CCPs) varies as a result of the coal source and combustion parameters, the iron-containing coal combustion product used in the process of the present invention may also vary. Typically, the iron-containing coal combustion product comprises from about 2% to about 40% iron oxide, including each value within the specified range. In other embodiments, the iron-containing coal combustion product comprises from about 5% to about 30% iron oxide, including each value within the specified range. In yet other embodiments, the iron-containing coal combustion product comprises less than 25% iron oxide. Exemplary contents of iron oxide within the coal combustion product include, but are not limited to, about 2%, about 5%, about 7%, about 10%, about 15%, about 20%, about 25%, about 30%, about 35%, or about 40%, with each possibility representing a separate embodiment. It is to be understood that that ratios and percentages used herein to define relative amounts of materials are referring to weight ratios and percentages. For examples, a coal combustion product, which weighs 100 gram and comprises 15 grams of iron oxide and 85 grams of other chemical compounds, is consider to be an iron-containing coal combustion product comprising 15% iron oxide. It is further to be understood that if a coal combustion product includes a number of different iron oxides (e.g., Fe in different oxidation states), the total amount of iron oxides is to be considered in the calculation of percentages. For examples, a coal combustion product, which weighs 100 gram and comprises 5 grams of iron (II) oxide (FeO), 5 grams of iron (II,III) oxide (Fe₃O₄), 10 grams of iron (III) oxide (Fe₂O₃) and 80 grams of other chemical compounds, is consider to be an iron-containing coal combustion product comprising 20% iron oxide.

The term “iron oxide”, as used herein refers to any compound comprising a chemical bond between an Fe atom and an O atom. According to some embodiments, the iron oxide comprises a divalent iron oxide, a trivalent iron oxide or a combination thereof. Each possibility represents a separate embodiment. In one embodiment, the iron oxide comprises a trivalent iron oxide. In several embodiments, the iron oxide comprises at least one of iron (II) oxide (FeO), iron (II,III) oxide (Fe₃O₄), iron (III) oxide (Fe₂O₃), and combinations thereof. According to other embodiments, the iron oxide is selected from the group consisting of iron (II) oxide (FeO), iron (II,III) oxide (Fe₃O₄), iron (III) oxide (Fe₂O₃), and combinations thereof. In other embodiments, the iron oxide is selected from the group consisting of iron (II,III) oxide (Fe₃O₄), iron (III) oxide (Fe₂O₃), and combinations thereof.

The coal combustion product typically also comprises as a major constituent silicon dioxide in a weight percent of from about 25% to about 75% silicon dioxide, including each value within the specified range. Exemplary amounts of silicon dioxide (either silica or quartz) include, but are not limited to, about 25%, about 30%, about 35%, about 40%, about 45%, about 50%, about 55%, about 60%, about 65%, about 70%, or about 75%, with each possibility representing a separate embodiment. In additional embodiments, the ratio between the iron oxide to the silicon dioxide in the iron-containing coal combustion product is in the range of about 1:1.5 to about 1:10, including all iterations of ratios within the specified range. In exemplary embodiments, the weight percent ratio of the iron oxide to the silicon dioxide in the iron-containing coal combustion product includes ratios of about 1:1.5, about 1:2, about 1:2.5, about 1:3, about 1:3.5, about 1:4, about 1:4.5, about 1:5, about 1:5.5, about 1:6, about 1:6.5, about 1:7, about 1:7.5, about 1:8, about 1:8.5, about 1:9, about 1:9.5, or about 1:10, with each possibility representing a separate embodiment. In addition, the coal combustion product typically also includes additional oxides such as, but not limited to, TiO₂, Al₂O₃, CaO, MgO, K₂O, Na₂O, and SO₃. The total amounts of the aforementioned additional oxides vary and are typically within the range of about 20% to about 50%, including each value within the specified range. By way of illustration and not limitation, the weight percent of TiO₂ is in the range of about 0.2% to about 3%, the weight percent of Al₂O₃ is in the range of about 5% to about 35%, the weight percent of CaO is in the range of about 1% to about 35%, the weight percent of MgO is in the range of about 0.1% to about 8%, the weight percent of K₂O is in the range of about 0.05% to about 4%, the weight percent of Na₂O is in the range of about 0.1% to about 3%, and the weight percent of SO₃ is in the range of about 0.1% to about 2.5%, including each value within the specified ranges. Further minor components of the coal combustion products include, but are not limited to, MnO, P₂O₅, SrO, and ZrO₂, the total amount of which by weight percent is typically about 5% or less.

Some embodiments of the present invention are based in part on the surprising discovery that NH₃ can be produced by reacting nitrogen, water, an iron-containing coal combustion product, and carbon dioxide (CO₂) or a carbon dioxide generator at relatively low temperatures without external heating. The process can further be used for recycling of coal combustion products and in carbon dioxide capture and storage. The inventor of the present invention has unexpectedly found that it is possible to produce NH₃ at room temperature while using high valent iron oxides from the waste of coal combustion. NH₃ is produced at high purity while affording recycling of the coal combustion waste which further provides a beneficial environmental advantage.

In other embodiments, the iron-containing coal combustion product is selected from the group consisting of coal ash, fly ash, bottom ash, boiler slag, and a mixture or combination thereof. Each possibility represents a separate embodiment. In particular embodiments, the iron-containing coal combustion product originates from a power plant, a fuel boiler, or from cement production. Each possibility represents a separate embodiment. According to some embodiments, the power plant is fired by coal or heavy oils. In several embodiments, the iron-containing coal combustion product comprises a divalent iron oxide, a trivalent iron oxide or a combination thereof. Each possibility represents a separate embodiment. In one embodiment, the iron-containing coal combustion product comprises a trivalent iron oxide. In specific embodiments, the iron-containing coal combustion product comprises at least one of iron (II) oxide (FeO), iron (II,III) oxide (Fe₃O₄), and iron (III) oxide (Fe₂O₃). Each possibility represents a separate embodiment.

In some embodiments, the iron-containing coal combustion product comprises from about 2% to about 40% iron oxide w/w, including each value within the specified range. In other embodiments, the iron-containing coal combustion product comprises from about 5% to about 30% iron oxide w/w, including each value within the specified range. In exemplary embodiments, the iron-containing coal combustion product comprises less than 25% iron oxide w/w. In further embodiments, the iron-containing coal combustion product comprises from about 25% to about 75% silicon dioxide w/w, including each value within the specified range. In additional embodiments, the weight ratio between the iron oxide and the silicon dioxide in the iron-containing coal combustion product is in the range of about 1:1.5 to about 1:10, including all iterations of ratios within the specified range.

In specific embodiments, the process further comprises pretreating the iron-containing coal combustion product prior to the step of contacting the water, the iron-containing coal combustion product, and the CO₂ source. In specific embodiments, the process further comprises pretreating the iron-containing coal combustion product prior to the step of contacting the water, the iron-containing coal combustion product, the nitrogen and the CO₂ source. In some embodiments, pretreating comprises at least one of milling the iron-containing coal combustion product and enriching the iron content in the iron-containing coal combustion product. Each possibility represents a separate embodiment. In particular embodiments, the iron-containing coal combustion product is milled to an average particle size of less than 100 μm, less than 75 μm, less than 50 μm, less than 25 μm, less than 10 μm, or even less than 5 μm. Each possibility represents a separate embodiment. For example, an average particle size of the iron-containing coal combustion product after milling is in the range of about 1 μm to about 100 μm, about 1 μm to about 50 μm, about 1 μm to about 10 μm, about 1 μm to about μm, or about 3 μm to about 5 μm, including each value within the specified ranges.

As detailed herein, the coal combustion product may be available at different particle or granule sizes (whether ash or slag), depending on the production. Typically, reactions of such insoluble solids are facilitated, when the solid has a large surface to bulk area. Therefore, the iron-containing coal combustion product may be provided in the form of granules having at least one dimension, which is sufficiently small/narrow, so as to enable a fast reaction, according to some embodiments.

Granularity generally refers to the extent to which a material or system is composed of distinguishable pieces. It can either refer to the extent to which a larger entity is subdivided, or the extent to which groups of smaller indistinguishable entities have joined together or aggregated to become larger distinguishable entities. The term “granule” as used herein, refers to the distinguishable pieces in the granulate. According to some embodiments, each granule is substantially spherical having a diameter in the range of 0.1-3 millimeters.

According to some embodiments, the iron-containing coal combustion product comprises three-dimensional granules, wherein at least one of the dimensions thereof is smaller than 1 centimeter. According to other embodiments, at least one of the dimensions of the iron-containing coal combustion product granules is smaller than centimeter. According to yet other embodiments, at least one of the dimensions of the iron-containing coal combustion product granules is smaller than 0.35 centimeter. According to additional embodiments, at least one of the dimensions of the iron-containing coal combustion product granules is smaller than 0.25 centimeter. According to further embodiments, at least one of the dimensions of the iron-containing coal combustion product granules is smaller than 0.15 centimeter. According to particular embodiments, at least one of the dimensions of the iron-containing coal combustion product granules is smaller than 0.1 centimeter.

The iron-containing coal combustion product may be pre-treated prior to its addition into the reactor. In some embodiments, pretreatment comprises milling or grinding the iron-containing coal combustion product to particles having an average particle size of less than about 10 μm. According to some embodiments, the process further comprises a step of milling or grinding the iron-containing coal combustion product to a powder. Milling or grinding, can be performed using any suitable method, e.g., milling, crushing, cutting, using any suitable device, e.g., vortex mill, jet mill, conical mill, ball mill, SAG mill (semi-autogenous grinding mill), pebble mill, roller press, buhrstone mill, VSI mill (vertical shaft impactor mill), tower mill or combinations thereof. Each possibility represents a separate embodiment. According to certain embodiments, milling or grinding is performed to obtain particles in sizes ranging from about 1 μm to about 10 μm, for example about 1 μm to about 5 μm, or about 3 μm to about 5 μm, including each value within the specified ranges. According to some embodiments, the milled iron-containing particles have an average particle size in the range of about 0.1 to about 0.9 mm, including each value within the specified range. According to other embodiments, the milled iron-containing particles have an average particle size in the range of about 0.15 to about 0.65 mm, including each value within the specified range. According to further embodiments, at least 50% of the total mass of the milled iron-containing particles is composed of particles having an average particle size in the range of about 0.1 to about 0.9 mm. According to some embodiments, at least 60% of the total mass of the milled iron-containing particles is composed of particles having an average particle size in the range of about 0.1 to about mm. According to other embodiments, at least 65% of the total mass of the milled iron-containing particles is composed of particles having an average particle size in the range of about 0.1 to about 0.9 mm. According to yet other embodiments, at least 70% of the total mass of the milled iron-containing particles is composed of particles having an average particle size in the range of about 0.1 to about 0.9 mm. According to additional embodiments, at least 75% of the total mass of the milled iron-containing particles is composed of particles having an average particle size in the range of about to about 0.9 mm. According to some embodiments, at least 50% of the total mass of the milled iron-containing particles is composed of particles having an average particle size in the range of about 0.15 to about 0.65 mm. According to other embodiments, at least 60% of the total mass of the milled iron-containing particles is composed of particles having an average particle size in the range of about 0.15 to about mm. According to yet other embodiments, at least 65% of the total mass of the milled iron-containing particles is composed of particles having an average particle size in the range of about 0.15 to about 0.65 mm. According to further embodiments, at least 70% of the total mass of the milled iron-containing particles is composed of particles having an average particle size in the range of about 0.15 to about 0.65 mm. According to additional embodiments, at least 75% of the total mass of the milled iron-containing particles is composed of particles having an average particle size in the range of about to about 0.65 mm.

While the inventor of the present invention surprisingly discovered that it is possible to produce ammonia at high purity even when using a coal combustion product containing less than 25% by weight of iron oxides, for example using slag containing about 5-10% iron oxides, the present invention further contemplates iron enrichment of the iron-containing coal combustion product or the ground iron-containing coal combustion. Typically, enrichment is affected such that the total amount or iron oxides increases by at least 10% of the initial amount, for example the total amount of iron oxides may be increased in at least about 10%, about 20%, about 30%, about 40%, about 50%, about 60%, about 70%, about 80%, about 90%, about 100%, about 150%, about 200%, or more. Each possibility represents a separate embodiment. Enrichment can be performed by various methods known in the art such as, but not limited to, beneficiation and leaching. Beneficiation processes include, among others, particle sizing, density separation, magnetic separation, and froth flotation. Each possibility represents a separate embodiment. Particle and magnetic separations using air classification and/or magnetic sieving are currently preferred due to the magnetic properties of iron. For example, cross belt and overband magnetic separators are commercial devices, whereby automatic magnetic separation may be performed.

Additional pre-treatment that can be performed on the coal combustion product includes, but is not limited to, washing with a washing solution selected from the group consisting of an aqueous solution, an acidic solution, a basic solution, an organic solvent, and a combination thereof. Each possibility represents a separate embodiment. Suitable acid solutions include, but are not limited to, sulfuric acid, phosphoric acid, hydrochloric acid, acetic acid, and citric acid. Each possibility represents a separate embodiment. Suitable base solutions include, but are not limited to, sodium hydroxide, potassium hydroxide, and ammonium hydroxide. Each possibility represents a separate embodiment.

According to some embodiments, the iron-containing material comprises an iron waste material. According to some embodiments, the iron metal comprises an iron waste metal. According to some embodiments, the iron-containing material is selected from iron slag and iron shavings. According to some embodiments, the iron metal is selected from iron slag and iron shavings. According to some embodiments, the iron waste material is selected from iron slag and iron shavings. According to some embodiments, the iron waste material is iron dust. According to some embodiments, the iron waste material is an iron mineral. According to some embodiments, the iron waste material comprises iron carbonate, wustite, troilite, pyrrhotite, pyrite or a combination thereof. According to some embodiments, the process further comprises converting the iron-containing material to a granular material. According to some embodiments, the process further comprises a step of pre-treating the iron-containing material prior to utilizing it in the process of the present invention. Pre-treatment, according to the principles of the present invention include, but is not limited to, separation of iron waste, size reduction as disclosed hereinabove, and washing the iron-containing material, or a combination thereof. According to some embodiments, the process comprises a step of washing the iron-containing material with a washing solution selected from the group consisting of an aqueous solution, an acidic solution, a basic solution, an organic solvent, and a combination thereof. In some embodiments, when iron waste is used as the iron-containing material, it may contain hydrocarbon-based contaminants (such as oils or lubricants) or inorganic based contaminants (such as sulfuric salts). The pre-treatment depends on the source of the iron and on the type of contaminant, such as washing with an organic solvent (e.g. alkyne to discard oils or lubricants) or an aqueous solution (to discard salt contaminants). The pre-treatment process may be conducted as is known in the art for example by mixing the iron-containing material with a solution of carbonate and bicarbonate ions at a concentration of at least 0.01M and pH of at least 6.5, followed by heating at a temperature above 100° C.

As detailed herein, it was surprisingly found that various sources of iron-containing material may be successfully employed in the reaction to produce high purity ammonia. This is beneficial as, in addition to the production of ammonia, the process of the current invention further provides a method of using waste materials, which would otherwise need to be disposed of with ecological costs. Iron waste may be available at different sizes, depending on the production factory and field. Typically, reactions of such insoluble solids are facilitated, when the solid has a large surface to bulk area. This is often not a major limitation, as many iron waste products are shavings, which are typically long and thin. Therefore, the iron-containing material preferably has at least one dimension, which is sufficiently small/narrow, so as to enable a fast reaction. According to some embodiments, the iron-containing material is a three-dimensional object, wherein at least one of the dimensions thereof is smaller than 1 centimeter. According to some embodiments, at least one of the dimensions of the iron-containing material is smaller than 0.5 centimeter. According to some embodiments, at least one of the dimensions of the iron-containing material is smaller than 0.35 centimeter. According to some embodiments, at least one of the dimensions of the iron-containing material is smaller than 0.25 centimeter. According to some embodiments, at least one of the dimensions of the iron-containing material is smaller than 0.15 centimeter. According to some embodiments, at least one of the dimensions of the iron-containing material is smaller than 0.1 centimeter.

It was surprisingly found that the nitrogen used as a starting material for the reaction is also not required to have a high purity. According to some embodiments, the nitrogen is provided as a gas mixture comprising at least 1% N₂ v/v. According to some embodiments, the nitrogen is provided as a gas mixture comprising at least 3% N₂ v/v. According to some embodiments, the nitrogen is provided as a gas mixture comprising at least 10% N₂ v/v. According to some embodiments, the nitrogen is provided as a gas mixture comprising at least 15% N₂ v/v. According to some embodiments, the nitrogen is provided as a gas mixture comprising at least 20% N₂ v/v. According to some embodiments, the nitrogen is provided as a gas mixture comprising at least 30% N₂ v/v. According to some embodiments, the nitrogen is provided as a gas mixture comprising at least 40% N₂ v/v. According to some embodiments, the nitrogen is provided as a gas mixture comprising at least 50% N₂ v/v. According to some embodiments, the nitrogen is provided as a gas mixture comprising at least 60% N₂ v/v. According to some embodiments, the nitrogen is provided as a gas mixture comprising at least 70% N₂ v/v. According to some embodiments, the nitrogen is provided as a gas mixture comprising at least 80% N₂ v/v. According to some embodiments, gas mixture comprises air. According to some embodiments, gas mixture is air.

According to some embodiments, the CO₂ source is CO₂. According to some embodiments, the CO₂ source is CO₂ provided as CO₂ gas. It is to be understood that in atmospheric conditions, CO₂ is in a gas state, however, in elevated gas pressure conditions and moderate temperatures, CO₂ may be in an equilibrium between a gas, a liquid and supercritical CO₂. It is further to be understood that depending on the environmental pressure, temperature and pH, CO₂ differs in its aqueous solubility. Thus, the CO₂ provided as CO₂ gas may be in different phases during the reaction progression, including gas, liquid, supercritical and dispersed in the water. Each possibility represents a separate embodiment.

According to some embodiments, it is preferred that the CO₂ source is CO₂, provided as CO₂ gas. Specifically, the utilization of CO₂ gas as a starting material contributes to Carbon Capture and Storage. In this application, the term “Carbon Capture and Storage” (CCS, also referred to as “Carbon Capture” and “Sequestration”), refers to the process of managing produced carbon dioxide, transporting it to a storage site, and depositing it where it will not enter the atmosphere. Specifically, the CO₂ is mainly a combustion waste emitted from large point sources, such as fossil fuel power plants. If the CO₂ source is not a production site but rather the CO₂ is removed from the atmosphere, then the process could alternatively be defined as Carbon Dioxide Removal (CDR). Thus, it is an environmental advantage to use CO₂ gas in the process thereby contributing to its capturing. According to some embodiments, the process comprises a step of streaming a gas containing CO₂. In other embodiments, the step of streaming a gas additionally comprises a step of concentrating the CO₂. In yet other embodiments, the process comprises a step of capturing atmospheric CO₂. In additional embodiments, the process comprises a step of streaming CO₂ generated by a CO₂ producing source. In some embodiments, the process of the present invention further comprises capturing CO₂ as a metal complex. In some embodiments, the process of the present invention further comprises capturing CO₂ as an iron complex thereby resulting in Carbon Capture and Utilization (CCU).

Importantly, the CO₂ gas is not required to be of specific high purity according to some embodiments. Thus, according to some embodiments, various sources of CO₂ gas may be used as the CO₂ source of the current process. According to some embodiments, the process further comprises a step of capturing atmospheric carbon dioxide. According to some embodiments, the process further comprises a step of concentrating the atmospheric carbon dioxide. According to some embodiments, at least part of the CO₂ source is CO₂ gas provided from a power plant, a biogas plant, a distillery, refinery, combustion engine, cement production plant, ammonia plant, steel, iron plant and gas wells. Each possibility represents a separate embodiment. According to some embodiments, the process further comprises a step of decontaminating the flue gas and/or concentrating the CO₂ provided by a CO₂ producing plant. According to some embodiments, at least part of the CO₂ source is flue gas comprising CO₂. According to some embodiments, the process further comprises a step of decontaminating the flue gas and/or concentrating the CO₂ in the flue gas. Specifically, typical contaminants in such industrial plant may comprise sulfur compounds, such as sulfur oxides and nitrogen compounds, such as nitric oxides. In some embodiments, CO₂ contaminants include metals such as mercury. Known decontamination methods involve technologies including, but not limited to, chemical reaction processes, physical and electrochemical methods.

According to some embodiments, the concentration of the CO₂ in the water is at least 5% w/w. According to some embodiments, the concentration of the CO₂ in the water is at least 10% w/w. According to some embodiments, the concentration of the CO₂ in the water is at least 15% w/w.

According to some embodiments, the CO₂ source is CO₂, provided as dry ice. The term “dry ice” refers to solid CO₂. According to some embodiments, the CO₂ source is CO₂, provided as powdered dry ice. According to some embodiments, the contacting of powdered dry ice and the iron containing material comprises producing a solid mixture of the powdered dry ice and the iron containing material. According to some embodiments, the contacting of powdered dry ice and the iron containing material comprises producing a solid dispersion comprising the powdered dry ice and the iron containing material.

It is to be understood that the CO₂ source of the current process is not limited to carbon dioxide gas, and may by a CO₂ precursor, which includes two reactants, which upon reaction, produce carbon dioxide.

According to some embodiments, the CO₂ source is a CO₂ precursor or generator. According to some embodiments, the CO₂ precursor comprises a combination of carbonate compound(s) or bicarbonate compound(s), and an acid(s).

According to some embodiments, the process further comprises contacting a carbonate compound or a bicarbonate compound with the water and the iron-containing material, and adding an acid to the formed dispersion. According to some embodiments, the acid addition is performed gradually. According to some embodiments, the process further comprises contacting CO₂ with the water and the iron-containing material, and adding a base to the formed dispersion. According to some embodiments, the process further comprises adding a base to the water and then contacting CO₂ with the basic water.

According to some embodiments, the CO₂ precursor comprises a carbonate selected from the group consisting of calcium carbonate, sodium carbonate, potassium carbonate, iron (II) carbonate, ammonium carbonate, magnesium carbonate, and combinations thereof. Each possibility represents a separate embodiment. The carbonate anion is represented by the chemical formula CO₃⁻².

According to some embodiments, the CO₂ precursor comprises a bicarbonate selected from the group consisting of calcium bicarbonate, sodium bicarbonate, potassium bicarbonate, iron (II) bicarbonate, ammonium bicarbonate, magnesium bicarbonate, and combinations thereof. Each possibility represents a separate embodiment. The bicarbonate anion is represented by the chemical formula HCO₃⁻.

According to some embodiments, the carbon dioxide concentration in the mixture formed from the CO₂ source, the water, and the iron-containing material is at least 1% w/w. According to some embodiments, the carbon dioxide concentration in the mixture formed from the CO₂ source, the water, and the iron-containing material is at least 2% w/w. According to some embodiments, the carbon dioxide concentration in the mixture formed from the CO₂ source, the water, and the iron-containing material is at least 3% w/w. According to some embodiments, the carbon dioxide concentration in the mixture formed from the CO₂ source, the water, and the iron-containing material is at least 5% w/w. According to some embodiments, the carbon dioxide concentration in the mixture formed from the CO₂ source, the water, and the iron-containing material is at least 7.5% w/w. According to some embodiments, the carbon dioxide concentration in the mixture formed from the CO₂ source, the water, and the iron-containing material is at least 10% w/w. According to some embodiments, the carbon dioxide concentration in the mixture formed from the CO₂ source, the water, and the iron-containing material is at least 12.5% w/w. According to some embodiments, the carbon dioxide concentration in the mixture formed from the CO₂ source, the water, and the iron-containing material is at least 15% w/w. According to some embodiments, the carbon dioxide concentration in the mixture formed from the nitrogen, the CO₂ source, the water, and the iron-containing material is selected from the group consisting of at least 1% w/w, at least 2% w/w, at least 3% w/w, at least 4% w/w, at least 5% w/w, at least 7.5% w/w, at least 10% w/w and at least 15% w/w. Each possibility represents a separate embodiment.

Without wishing to be bound by any theory or mechanism of action, carbonic acid (H₂CO₃) is formed upon the contact of CO₂ and water, and the pH is lowered to below 7, according to some embodiments. However, it is not intended to mean that the reaction mixture for forming ammonia is necessarily acidic (e.g., due to the contribution of carbonic acid) or basic (e.g., due to the contribution of the basic ammonia). According to some embodiments, the CO₂ source and the water are contacted prior to addition of the iron-containing material, such that an aqueous solution of carbonic acid is formed having pH ranging between 5.7 and 6.0. The solution can be prepared in a reactor or pre-prepared in a saturation unit. According to some embodiments, the saturation unit is pre-cooled to a temperature of <10° C. The saturation unit can be a Gas Addition Module, a Saturator Column or a pressure pump. According to some variants, nitrogen is added to the saturation unit. If the solution is prepared outside of the reactor, a high-pressure pump is used to load the solution into the reactor. Once prepared, the solution must be kept under pressure, according to some embodiments. According to some embodiments, the pressure is >1 Bar.

According to some embodiments, addition of nitrogen to the closed reactor, the pressure within the closed reactor is above the ambient pressure. According to some embodiments, the pressure within the closed reactor is at least 1.1 Bar. According to some embodiments, the pressure within the closed reactor is at least 1.5 Bar. According to some embodiments, the pressure within the closed reactor is at least 2 Bar. According to some embodiments, the pressure within the closed reactor is at least 3 Bar. According to some embodiments, the pressure within the closed reactor is at least 5 Bar. According to some embodiments, the pressure within the closed reactor is at least 10 Bar. According to some embodiments, the pressure within the closed reactor is at least 15 Bar. According to some embodiments, the pressure within the closed reactor is at least 20 Bar. According to some embodiments, the pressure within the closed reactor is at least 25 Bar. According to some embodiments, the pressure within the closed reactor is at least 30 Bar. According to some embodiments, the pressure within the closed reactor is at least 35 Bar. According to some embodiments, the pressure within the closed reactor is at least 40 Bar. According to some embodiments, the pressure within the closed reactor is at least 45 Bar. According to some embodiments, the pressure within the closed reactor is at least 50 Bar. According to some embodiments, the pressure within the closed reactor is at least 75 Bar. According to some embodiments, the pressure within the closed reactor is at least 100 Bar. According to some embodiments, the pressure within the closed reactor is at least 150 Bar.

Typically, the process is performed at a pressure of about 1 to about 350 Bar, including each value within the specified range. In other embodiments, the process is performed at a pressure of about 50 to about 350 Bar, including each value within the specified range. In other embodiments, the process is performed at a pressure of about 60 to about 350 Bar, including each value within the specified range. In other embodiments, the process is performed at a pressure of about 70 to about 350 Bar, including each value within the specified range. In other embodiments, the process is performed at a pressure of about 80 to about 350 Bar, including each value within the specified range. In further embodiments, the process is performed at a pressure of about 90 to about 350 Bar. In other embodiments, the process is performed at a pressure of about 100 to about 350 Bar. According to some embodiments, the process is performed at a pressure of about 105 to about 350 Bar.

According to some embodiments, during the step of maintaining the reaction mixture after the addition of nitrogen substantially sealed for a period of time, the pressure inside the closed reactor ranges from about 70 to about 350 Bar. According to some embodiments, during the step of maintaining the reaction mixture after the addition of nitrogen substantially sealed for a period of time, the pressure inside the closed reactor ranges from about 100 to about 350 Bar. According to some embodiments, during the addition of nitrogen to the closed reactor, the pressure within the closed reactor is above the ambient pressure. According to some embodiments, the pressure within the closed reactor is at least 1.1 Bar. According to some embodiments, the pressure within the closed reactor is at least 1.5 Bar. According to some embodiments, the pressure within the closed reactor is at least 2 Bar. According to some embodiments, the pressure within the closed reactor is at least 3 Bar. According to some embodiments, the pressure within the closed reactor is at least 5 Bar. According to some embodiments, the pressure within the closed reactor is at least 10 Bar. According to some embodiments, the pressure within the closed reactor is at least 15 Bar. According to some embodiments, the pressure within the closed reactor is at least 20 Bar. According to some embodiments, the pressure within the closed reactor is at least 25 Bar. According to some embodiments, the pressure within the closed reactor is at least 30 Bar. According to some embodiments, the pressure within the closed reactor is at least 35 Bar. According to some embodiments, the pressure within the closed reactor is at least 40 Bar. According to some embodiments, the pressure within the closed reactor is at least 45 Bar. According to some embodiments, the pressure within the closed reactor is at least 50 Bar. According to some embodiments, the pressure within the closed reactor is at least 75 Bar. According to some embodiments, the pressure within the closed reactor is at least 100 Bar. According to some embodiments, the pressure within the closed reactor is at least 150 Bar.

Typically, the process is performed at a pressure of about 1 to about 350 Bar, including each value within the specified range. In other embodiments, the process is performed at a pressure of about 80 to about 350 Bar, including each value within the specified range. In further embodiments, the process is performed at a pressure of about to about 350 Bar. In other embodiments, the process is performed at a pressure of about 100 to about 350 Bar. According to some embodiments, the process is performed at a pressure of about 105 to about 350 Bar.

According to some embodiments, during the step of maintaining the reaction mixture after the addition of nitrogen substantially sealed for a period of time, the pressure inside the closed reactor ranges from about 70 to about 350 Bar. According to some embodiments, during the step of maintaining the reaction mixture after the addition of nitrogen substantially sealed for a period of time, the pressure inside the closed reactor ranges from about 105 to about 350 Bar. According to some embodiments, during the step of maintaining the reaction mixture after the addition of nitrogen substantially sealed for a period of time, the pressure inside the closed reactor ranges from about 100 to about 350 Bar. Each possibility represents a separate embodiment.

According to some aspects and embodiments, the period of time for process of the present invention, according to the principles of the present invention is at least minutes, for example about 30 minutes to 1 week, including each value within the specified range. According to some aspects and embodiments, the period of time for the reaction between water, the iron-containing material, the nitrogen and the CO₂ source, according to the principles of the present invention is at least 60 minutes, for example about 60 minutes to about one week including each value within the specified range. Exemplary time periods during which the reactions takes place include, but are not limited to, about 30 minutes, about 1 hour, about 2 hours, about 3 hours, about 4 hours, about 5 hours, about 6 hours, about 7 hours, about 8 hours, about 10 hours, about 12 hours, about 15 hours, about 18 hours, about 20 hours, about 22 hours, about 24 hours, about 48 hours, about 72 hours, about 4 days, about 5 days, about 6 days or about 7 days with each possibility representing a separate embodiment.

According to some embodiments, the process further comprises a step of adding an acid to the water. According to some embodiments, the step of adding an acid is conducted after reaction initiation. According to some embodiments, the step of adding an acid is conducted at least 1 minute after reaction initiation. According to some embodiments, the acid is selected from a group consisting of sulfuric acid, phosphoric acid, hydrochloric acid, acetic acid, and citric acid. Each possibility represents a separate embodiment.

According to some embodiments, the pH of the reaction is 6.5 or less. According to some embodiments, the pH of the reaction is 6.4 or less. According to some embodiments, the pH of the reaction is 6.3 or less. According to some embodiments, the pH of the reaction is 6.2 or less. According to some embodiments, the pH of the reaction is 6.1 or less. According to some embodiments, the pH of the reaction is 6.0 or less. According to some embodiments, the pH of the reaction is 5.9 or less. According to some embodiments, the pH of the reaction is 5.8 or less. According to some embodiments, the pH of the reaction is 5.7 or less. According to some embodiments, the pH of the reaction is 5.6 or less. According to some embodiments, the pH of the reaction is 5.5 or less. According to some embodiments, the pH of the reaction is 5.4 or less. According to some embodiments, the pH of the reaction is 5.3 or less. According to some embodiments, the pH of the reaction is 5.2 or less. According to some embodiments, the pH of the reaction is 5.1 or less. According to some embodiments, the pH of the reaction is 5.0 or less. In further embodiments, the pH of the reaction is about 4 to about 6, including each value within the specified range.

Alternatively, according to some embodiments, the pH of the reaction is at least 6.5. In other embodiments, the pH of the reaction is at least 7. In certain embodiments, the pH of the reaction is at least 7.5. In further embodiments, the pH of the reaction is about 6.5 to about 10, including each value within the specified range.

According to some embodiments, the process further comprises a step of adding an anti-caking agent to the water. Suitable anti-caking agents include, but are not limited to, tricalcium phosphate, powdered cellulose, magnesium stearate, sodium ferrocyanide, potassium ferrocyanide, calcium ferrocyanide, calcium phosphate, sodium silicate, silicon dioxide, calcium silicate, magnesium trisilicate, talcum powder, sodium aluminosilicate, potassium aluminum silicate, calcium aluminosilicate, bentonite, aluminum silicate, stearic acid, polydimethylsiloxane, and a mixture or combination thereof. Each possibility represents a separate embodiment.

It is to be understood that silicon dioxide includes, but is not limited to, silica, such as fumed silica.

According to some embodiments, the anti-caking agent is added at a concentration of between 1% and 10% w/w based on the weight of the dispersion formed from the anti-caking agent, the water, the iron-containing material, and the CO₂ source. According to some embodiments, the anti-caking agent is a surfactant that has an amphiphilic structure. According to some embodiments, the anti-caking agent comprises at least one functional group selected from a group consisting of —OH, —COOH, —SOOOH, and salts thereof. Each possibility represents a separate embodiment. According to some embodiments, the anti-caking agent is selected from a group consisting of silica compounds, fumed silica, and pyrogenic silicon dioxide.

An anti-caking or anti-agglomerating agent may be added to the reaction mixture according to some embodiments. The agent may be added at a concentration of less than 10% of the reaction mixture, according to some embodiments. It is to be understood that the anti-caking agent is intended to prevent agglomeration or clumping of the iron-containing material, acting as a dispersant, affecting the adsorption properties. The addition of the agent may result in a more hygroscopic mixture. In one embodiment, the anti-caking agent is silica based, such as fumed or pyrogenic silica, and a mixture or combination thereof. Each possibility represents a separate embodiment.

Although addition of specific additives as detailed above may contribute to specific parameters of the present invention, some implementations of the production of ammonia may benefit from the absence of additives, such as organic compounds. According to some embodiments, the process does not include the addition of organic compounds. According to other embodiments, the process does not include the addition of compounds other than the water, nitrogen, the iron-containing material product, and the CO₂ source.

It is to be understood that the process presented herein may be performed with a standard closed reactor, which is typically suitable for performing reactions involving a gas as a product and/or as a stating material, according to some embodiments. The reaction may be conducted batch-wise or continuously, with each possibility representing a separate embodiment. Specifically, according to some embodiments, the reaction may be performed as a batch process (e.g., in a batch reactor), for producing separate batches of ammonia in separate reactions, or it may be performed as a continuous process using a series of batch reactors or a continuous flow reactor for continuous production of ammonia. Provided below are non-limiting examples of conventional reactors, in which reactions, such as the reaction of the current invention, may take place.

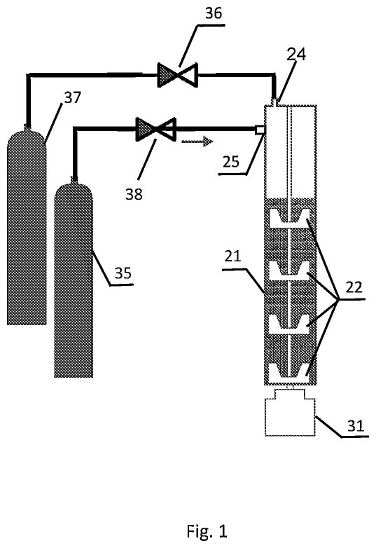

Reference is now made to FIG. 1. It is within the scope of this invention that the process is performed as a batch process for the production of ammonia. FIG. 1 represents a standard configuration of a system for batch production of ammonia according to some embodiments. According to some embodiments, the process of the present invention is performed as a batch for the production of ammonia, for example in reactor 21, as presented herein. In some embodiments, the reactor 21 comprises at least one mixing unit 22. The reactor 21 may be constructed from a non-reactive material; capable of withstanding pressure of up to 350 Bar or more. The mixing unit 22 can be active, passive or static. Active mixing units 22 can be based on mechanical, magnetic, ultrasonic, or high-pressure liquid mixers as is known in the art, powered by a mechanical or magnetic motor 31. In some embodiments, the mixture within reactor 21 is mixed by circulation. The reactor 21 comprises a feeding/loading opening 25, suitable for the addition of CO₂ gas contained in a CO₂ gas cylinder 35. The reactor 21 also comprises a feeding/loading opening 24, suitable for the addition of N₂ gas contained in an N₂ gas cylinder 37. Specifically, CO₂ gas cylinder 35 is configured to store carbon dioxide required for the reaction and N₂ gas cylinder 37 is configured to store nitrogen required for the reaction.

In some embodiments, the reactor 21 includes a gas pressurizing system for pressurizing the nitrogen upon its insertion to the reactor 21, wherein the gas pressurizing system comprising a controller, such as a gas regulator, one-way valve 36 or a facet. Similarly, in some embodiments, the reactor 21 includes a gas pressurizing system for pressurizing the carbon dioxide upon its insertion to the reactor 21, wherein the gas pressurizing system comprising a controller, such as a gas regulator one-way valve 38 or a facet. Generally, according to some embodiments, it is preferred to added the CO₂ gas before the addition of nitrogen, as CO₂ tends to condense under high pressure. Alternatively, CO₂ may be added as a solid, i.e. dry ice, before the addition of nitrogen, according to some embodiments. It is also to be understood that the water and the iron containing material of the present invention are typically added before the addition of gas(es), as conventionally done in reactions, which involve gasses and non-gasses. According to some embodiments, the system for batch production of ammonia further comprises a ball valve and/or a pressure regulator (not numbered), for determining the pressure inside reactor 21.

As used herein and in the appended claims, the singular forms “a”, “an”, and “the” include plural references unless the context clearly dictates otherwise. Thus, for example, reference to “an iron-containing material” includes a plurality of iron-containing materials. It should be noted that the term “and” or the term “or” is generally employed in its sense including “and/or” unless the context clearly dictates otherwise. As used herein, the term “about” is meant to encompass variations of ±10%.

### EXAMPLES

The following examples are presented in order to more fully illustrate certain embodiments of the invention. They should in no way, however, be construed as limiting the broad scope of the invention. One skilled in the art can readily devise many variations and modifications of the principles disclosed herein without departing from the scope of the invention.

### Example 1

Three hundred and twenty milliliters (320 ml) of water are mixed with 1000 gr of iron (Fe⁰, 99.9% purity, particle size: 2.5-3.5 microns, Sigma Aldrich) in a 1000 ml reactor at room temperature (25° C.). Following the mixing, 78 gr of carbon dioxide (Technical grade, Sigma Aldrich) and 130 gr of N₂ are added to the reactor. The reactor is kept sealed for 72 hours leading to the formation of ammonia, iron (II) oxide and iron carbonate. No external energy is supplied.

### Example 2

Three hundred and twenty milliliters (320 ml) of water are mixed with 1000 gr of iron (Fe⁰, 99.9% purity, particle size: 2.5-3.5 microns, Sigma Aldrich) in a 1000 ml reactor at room temperature (25° C.). Following the mixing, 78 gr of carbon dioxide (Technical grade, Sigma Aldrich) are added to the reactor. The reactor is kept sealed for 24 hours. No external energy is supplied. After 24 hours, formation of hydrogen is complete and 130 gr of N₂ are added to the reactor. The reactor is kept sealed for 72 hours leading to the formation of ammonia, iron (II) oxide and iron carbonate. No external energy is supplied throughout the process.

### Example 3

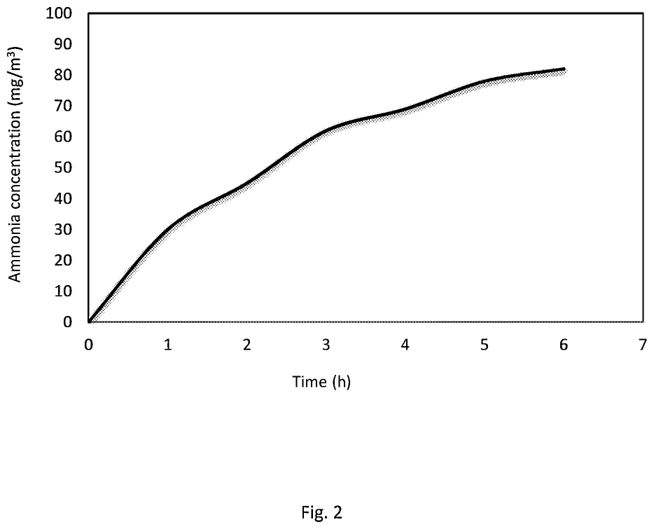

One kg (1 kg) of Fe-alloy was mixed with 2.5 Liters of water. The mix was placed in a 3 Liter high-pressure metal reactor. After sealing the reactor, carbon dioxide and nitrogen were added to a pressure of 50 bars. The experiment was conducted at room temperature and no external energy was supplied. The levels of NH₃, CO₂, N₂ and H₂ were measured at regular intervals. The concentrations of H₂, N₂ and CO₂ were determined by gas analyzers and expressed in % (v/v). After 6 hours, the level of CO₂+N₂ in the gas fraction declines to 63% (v/v) while the hydrogen level reached 16% (v/v). The level of NH₃ in the gas fraction was evaluated by colorimetric method with Nessler's reagent and is expressed in mg/m³. After 6 hours the ammonia content in the gas fraction was 82 mg/m³. (FIG. 2).

### Example 4

Example 3 was repeated and the reaction was conducted at room temperature for 24 h. At the end of the experiment the reactor was opened and the solid fraction was analyzed to reveal its composition. Table 2 describes the main iron compounds found in the used iron reactant. As could be seen, most abundant compound is iron carbonate and the second one is iron oxide (II).

| Compound | Content (%, w/w) |
|---|---|
| Fe₃O₄ | 5.39 ± 0.03% |
| FeO | 16.72 ± 0.03% |
| FeCO₃ | 75.35 ± 0.04% |
| Fe₂O₃ | 2.54 ± 0.01% |
| FeS | 0.21 ± 0.00% |

While certain embodiments of the invention have been illustrated and described, it is to be clear that the invention is not limited to the embodiments described herein. Numerous modifications, changes, variations, substitutions and equivalents will be apparent to those skilled in the art without departing from the spirit and scope of the present invention as described by the claims, which follow.

1. A process for producing NH₃, the process comprising contacting water, an iron-containing material, and a CO₂ source selected from the group consisting of CO₂ and a CO₂ precursor with nitrogen (N₂) in a reactor thereby producing NH₃.

2. The process of claim 1, comprising contacting a mixture of the water, the iron-containing material and the CO₂ source with the nitrogen.

3. The process of claim 2, comprising contacting of the water, the iron-containing material, and the CO₂ source for a period of time followed by admixing of nitrogen thereby producing NH₃.

4. The process of claim 1, which is performed in a single step in a closed reactor.

5. The process of claim 1, further comprising a step of collecting the produced NH₃.

6. The process of claim 1, wherein the process is performed in the absence of electrolysis.

7. The process of claim 1, which is performed in the absence of irradiation in a closed reactor.

8. The process of claim 1, wherein the process is performed at a temperature of about 290° C. or less.

9-10. (canceled)

11. The process of claim 1, which is performed in the absence of external energy.

12. The process of claim 1, further comprising recycling of iron waste thereby producing an iron oxide, iron carbonate, or both.

13. The process of claim 1, further comprising capturing of carbon dioxide.

14. The process of claim 1, wherein water is selected from the group consisting of tap water, sea water, partially purified water, deionized water, distilled water, brackish water, and waste water.

15. The process of claim 1, wherein water is in a liquid state.

16. The process of claim 1, wherein the iron-containing material is selected from the group consisting of an iron metal Fe⁰, an iron alloy, an Fe⁰ complex, an iron oxide, an iron carbonate, and a mixture or combination thereof.

17. The process of claim 16, wherein the iron-containing material is an iron metal Fe⁰.

18. The process of claim 1, wherein the iron-containing material comprises iron-containing coal combustion product.

19. (canceled)

20. The process of claim 1, wherein the iron-containing material is in the form of a powder having an average particle size in the range of about 1.5 to about 4.5 μm.

21. The process of claim 1, wherein the CO₂ source is a CO₂ gas, wherein the CO₂ gas is originated from at least one of pure industrial CO₂, flue gas, a CO₂-producing plant, and atmospheric CO₂.

22-24. (canceled)

25. The process of claim 1, wherein at least one of the water, the nitrogen, the iron-containing material and the CO₂ source is pre-treated prior to the step of contacting thereof.

26-27. (canceled)

28. The process of claim 1, which is performed at a pressure of about 100 Bar to about 350 Bar.

29-32. (canceled)
